(19) United States
(12) Patent Application Publication
(10) Pub. No.: US 2017/0348666 A1
(43) Pub. Date: Dec. 7, 2017

(54) METHODS OF ROUTING, COMPOSITIONS AND USES THEREOF

(71) Applicant: DiCE Molecules SV, LLC, Redwood City, CA (US)

(72) Inventors: Phillip Patten, Portola Valley, CA (US); Madan Paidhungat, San Francisco, CA (US); Pehr Harbury, Portola Valley, CA (US); Robin Prince, San Carlos, CA (US); Craig Skinner, Novato, CA (US); Malathy Sridhar, Fremont, CA (US)

(21) Appl. No.: 15/614,575

(22) Filed: Jun. 5, 2017

Related U.S. Application Data
(60) Provisional application No. 62/429,252, filed on Dec. 2, 2016.
(60) Provisional application No. 62/345,826, filed on Jun. 5, 2016.

(51) Int. Cl. B01J 19/00

(52) U.S. Cl. CPC B01J 19/0046; B01J 2219/00722; B01J 2219/005; B01J 2219/00563; B01J 2219/00596

(57) ABSTRACT

Provided herein are architectures and compositions of capture templates and macro capture templates, optionally attached to dendrimers, methods of using capture templates and/or macro capture templates, optionally attached to dendrimers to route coding templates, novel combinations including solid supports and capture templates and/or macro capture templates, optionally attached to dendrimers, methods of using novel combinations of solid supports and dendrimers and capture templates and/or macro capture templates to route coding templates, novel compositions which include capture templates and macro capture templates, optionally attached to dendrimers, hybridized to coding templates and novel compositions including solid supports, and capture templates and/or macro capture templates optionally attached to dendrimers hybridized to coding templates.

This application claims priority under 35 U.S.C. §119 (e) from U.S. Provisional Application Ser. Nos. 62/345,826 and 62/429,252, filed Jun. 5, 2016 and Dec. 2, 2016, respectively, which are hereby incorporated by reference in their entirety.

### FIELD

Provided herein are architectures and compositions of capture templates and macro capture templates, optionally attached to dendrimers, methods of using capture templates and/or macro capture templates, optionally attached to dendrimers to route coding templates, novel combinations including solid supports and capture templates and/or macro capture templates, optionally attached to dendrimers, methods of using novel combinations of solid supports and dendrimers and capture templates and/or macro capture templates to route coding templates, novel compositions which include capture templates and macro capture templates, optionally attached to dendrimers, hybridized to coding templates and novel compositions including solid supports, and capture templates and/or macro capture templates optionally attached to dendrimers hybridized to coding templates.

### BACKGROUND

Combinatorial libraries of small molecules, which were first developed over twenty years ago, are now routinely used to identify novel, high affinity ligands for wide variety of biological targets (e.g., receptors, enzymes, nucleic acids, etc.) and hence are of increasing importance in drug discovery. Combinatorial libraries, particularly libraries which use DNA as a tag to record synthetic steps undergone by ligands operatively attached to DNA (Pedersen et al., U.S. Pat. No. 7,277,713; Pedersen et al., U.S. Pat. No. 7,413,854; Gouliev et al., U.S. Pat. No. 7,704,925; Franch et al., U.S. Pat. No. 7,915,201; Gouliev et al., U.S. Pat. No. 8,722,583; Freskgard et al., U.S. Patent Application No. 2006/0269920; Freskgard et al., U.S. Patent Application No. 2012/0028812; Hansen et al., U.S. Pat. No. 7,928,211; Hansen et al., U.S. Pat. No. 8,202,823; Hansen et al., U.S. Patent Application No. 2013/0005581; Hansen et al., U.S. Patent Application No. 2013/0288929; Morgan et al., U.S. Pat. No. 7,972,992; Morgan et al., U.S. Pat. No. 7,935,658; Morgan et al., U.S. Patent Application No. 2011/0136697; Morgan et al., U.S. Pat. No. 7,972,994; Morgan et al., U.S. Pat. No. 7,989,395; Morgan et al., U.S. Pat. No. 8,410,028; Morgan et al., U.S. Pat. No. 8,598,089; Morgan et al., U.S. patent application Ser. No. 14/085,271; Wagner et al., U.S. Patent Application No. 2012/0053901; Keefe et al., U.S. Patent Application No. 2014/0315762; Dower et al., U.S. Pat. No. 6,140,493; Lerner et al., U.S. Pat. No. 6,060,596; Dower et al., U.S. Pat. No. 5,789,162; Lerner et al., U.S. Pat. No. 5,723,598; Dower et al.; U.S. Pat. No. 5,708,153; Dower et al., U.S. Pat. No. 5,639,603; and Lerner et al., U.S. Pat. No. 5,573,905) and in some cases to direct, synthetic steps undergone by ligands operatively attached to DNA (Harbury, et al., U.S. Pat. No. 7,479,472; Harbury et al., U.S. Patent Application No. US2006/0099626; Liu et al., U.S. Pat. No. 7,070,928; Liu et al., U.S. Pat. No. 7,223,545; Liu et al., U.S. Pat. No. 7,442,160; Liu et al., U.S. Pat. No. 7,491,160; Liu et al., U.S. Pat. No. 7,557,068; Liu et al., U.S. Pat. No. 7,771,935; Liu et al., U.S. Pat. No. 7,807,408; Liu et al., U.S. Pat. No. 7,998,904; Liu et al., U.S. Pat. No. 8,017,323; and Liu et al., U.S. Pat. No. 8,183,178) are of particular current interest. Advances in DNA sequencing, PCR technology and ligand binding assays, provide methods to identify and select ligands operatively linked to DNA that bind to a biological target, from complex mixtures of combinatorial ligands.

However, although most complex small molecule combinatorial libraries are made by split and pool synthetic procedures, only libraries made by methods where splitting is driven by polymers that form Watson Crick base pairs can evolve through in vitro selection. Here, polymer sequence uniquely directs chemical synthesis of the ligand and hence each ligand is encoded by the attached polymer. Accordingly, each unique polymer sequence (i.e., coding template) must be routed (i.e., spatially localized) through an exclusive pathway to provide a unique attached ligand during library synthesis.

Although methods of routing polymers (i.e., coding templates) to discrete spatial locations are described in the art (Harbury et al., U.S. Pat. No. 7,479,472; Harbury et al., U.S. Patent Application No. 2006/0099626; Wrenn et al., J. Am. Chem. Soc., 129(43), 13137, 2007; Weisinger et al., PLOS, e28056, 2012; Halpin et al., PLOS, 1015, 2004; Halpin et al., PLOS, 1022, 2004; Halpin et al., PLOS, 1031, 2004; and Glokler et al., International Publication No. WO 2012/004204) increasing coding template density and hybridization rates is needed for development of novel and potentially superior methods of routing polymer sequences.

### SUMMARY

The present invention satisfies these and other needs by providing architectures and compositions of capture templates and macro capture templates, optionally attached to dendrimers, methods of using capture templates and/or macro capture templates, optionally attached to dendrimers to route coding templates, novel combinations including solid supports and capture templates and/or macro capture templates, optionally attached to dendrimers, methods of using novel combinations of solid supports and dendrimers and capture templates and/or macro capture templates to route coding templates, novel compositions which include capture templates and macro capture templates, optionally attached to dendrimers, hybridized to coding templates and novel compositions including solid supports, and capture templates and/or macro capture templates optionally attached to dendrimers hybridized to coding templates.

In one aspect, a method of routing mixtures of n coding templates to more than one spatial location is provided where n is an integer greater than 1. The method includes the steps of adding the mixture of coding templates to spatially localized capture templates, forming base specific duplexes between coding templates complementary to the spatially localized capture templates, transferring the unhybridized coding templates to other spatially localized capture templates, forming base specific duplexes between the coding templates complementary to the spatially localized capture templates and either transferring the unhybridized coding templates to another spatial location or repeating the third and fourth steps n−1 times.

In another aspect, a method of routing mixtures of n coding templates into more than one spatial location is provided where n is an integer greater than 1. The method includes the steps of adding the mixture of coding templates to spatially localized macro capture templates, forming base specific duplexes between coding templates complementary to the spatially localized macro capture templates, transferring the unhybridized coding templates to other spatially localized macro capture templates, forming base specific duplexes between the coding templates complementary to the spatially localized macro capture templates and either transferring the unhybridized coding templates to another spatial location or repeating the third and fourth steps n−1 times.

In still another aspect, a method of routing mixtures of coding templates to more than one spatial location is provided. The method includes the steps of adding more than one capture template spatially localized with a multivalent device to a mixture of coding templates and forming base specific duplexes between the coding templates and the spatially localized capture templates.

In still another aspect, a method of routing mixtures of coding templates to more than one spatial location is provided. The method includes the steps of adding more than one macro capture templates spatially localized with a multivalent device to a mixture of coding templates and forming base specific duplexes between the coding templates and the spatially localized macro capture templates.

In still another aspect, a method of routing mixtures of coding templates to more than one spatial location is provided. The method includes the steps of adding the mixture of coding templates to more than one capture template, where each capture template includes at least one secondary capture template, forming base specific duplexes between coding templates and complementary capture templates, forming base specific duplexes between the secondary capture templates and complementary oligonucleotides attached to spatially localized beads, sortable beads, solid supports in spatially localized containers or in sortable containers.

In still another aspect, a method of routing mixtures of coding templates to more than one spatial location is provided. The method includes the steps of adding the mixture of coding templates to more than one macro capture template, base specific duplexes between coding templates and complementary capture templates, forming base specific duplexes between the secondary capture templates and complementary oligonucleotides attached to spatially localized beads, sortable beads, solid supports in spatially localized containers or in sortable containers.

In still another aspect, a method of routing mixtures of coding templates to more than one spatial location is provided. The method includes the steps of adding the mixture of coding templates to more than one capture template, wherein each capture template is attached to a dendrimer and which includes at least one secondary capture template, forming base specific duplexes between the coding templates and complementary capture templates attached to the dendrimers and forming base specific duplexes between the secondary capture templates and complementary oligonucleotides attached to spatially localized beads, sortable beads, solid supports in spatially localized containers or in sortable containers.

In still another aspect, a method of routing mixtures of coding templates to more than one spatial location is provided. The method includes the steps of adding the mixture of coding templates to more than one macro capture template, where each macro capture template is attached to a dendrimer, forming base specific duplexes between the coding templates and complementary macro capture templates attached to the dendrimers and forming base specific duplexes between secondary capture templates and complementary oligonucleotides attached to spatially localized beads, sortable beads, solid supports in spatially localized containers or in sortable containers.

In still another aspect, a method of routing mixtures of coding templates to more than one spatial locations is provided. The method includes the steps of adding the mixture of coding templates to more than one capture template, wherein each capture template includes a label and is attached to a dendrimer, forming base specific duplexes between the coding templates and complementary capture templates attached to the dendrimers and using the label to attach the dendrimers to spatially localized beads, sortable beads, solid supports in spatially localized containers or in sortable containers.

In still another aspect, a method of routing mixtures of coding templates to more than one spatial locations is provided. The method includes the steps of adding the mixture of coding templates to more than one macro capture template, wherein each macro capture template includes a label and is attached to a dendrimer, forming base specific duplexes between the coding templates and complementary capture templates attached to the dendrimers and using the label to attach the dendrimers to spatially localized beads, sortable beads, solid supports in spatially localized containers or in sortable containers.

In still another aspect, a method of routing mixtures of coding templates to more than one spatial location is provided. The method includes the steps of adding the mixture of coding templates to more than one capture template, where each capture template is attached to a dendrimer which includes a unique label, forming base specific duplexes between the coding templates and complementary capture templates attached to the dendrimers and using the label to attach the dendrimers to spatially localized beads, sortable beads, solid supports in spatially localized containers or in sortable containers.

In still another aspect, a method of routing mixtures of coding templates to more than one spatial location is provided. The method includes the steps of adding the mixture of coding templates to more than one macro capture template, where each macro capture template is attached to a dendrimer which includes a unique label, forming base specific duplexes between the coding templates and complementary capture templates of the capture templates attached to the dendrimers and using the label to attach the dendrimers to spatially localized beads, sortable beads, solid supports in spatially localized containers or in sortable containers.

In still another aspect, a method of routing mixtures of coding templates to more than one spatial location is provided. The method includes the steps of adding the mixture of coding templates to n macroscopic beads where each macroscopic bead includes attached capture templates and unique attached labels, forming base specific duplexes between the coding templates and the complementary capture templates of the macroscopic beads, sorting the n macroscopic beads to n spatial locations, using the label to identify the bead, eluting the coding templates from the bead and arraying the coding templates to n spatial locations.

In still another aspect, a method of routing mixtures of coding templates to more than one spatial location is provided. The method includes the steps of adding the mixture of coding templates to n macroscopic beads where each macroscopic bead includes attached macro capture templates and unique attached labels, forming base specific duplexes between the coding templates and the complementary capture templates of the macroscopic beads, sorting the n macroscopic beads to n spatial locations, using the label to identify the bead, eluting the coding templates from the bead and arraying the coding templates to n spatial locations.

In still another aspect, novel compositions which include capture templates and macro capture templates, optionally attached to dendrimers, hybridized to coding templates are provided.

In still another aspect novel compositions including solid supports, optionally dendrimers and capture templates and/or macro capture templates hybridized to coding templates are provided,

### BRIEF DESCRIPTION OF THE FIGURES

FIG. 1 shows an exemplary DNA-directed splitting of a library of fragments. The degenerate family of nucleic acid tags in this example is composed of catenated 20 base-pair nucleotide sequences, which are either constant (C₁-C₅) or variable (a₁-j₄). The letters a₁ through j₄ in the variable regions of the DNA fragments denote distinct 20 nucleotide sequences with orthogonal hybridization properties. To carry out the first split, the degenerate family of fragments is passed over a set of ten different affinity resins displaying the sequences a₁^{c}-j₁^{c}, which are complementary to the sequences a₁-j₁ in the first variable region. Ten sub-pools of the original family of fragments result. Each sub-pool of nucleic acid tags is then reacted with a distinct chemical subunit to allow for coupling of the distinct chemical subunit at the chemical reaction site of each nucleic acid tag. The sub-pools are then recombined, and the library is split into a new set of sub-pools based on the sequences a₂-j₂, etc.

FIG. 2 shows an exemplary chemical coupling reaction at the chemical reaction site of a nucleic acid tag. A nucleic acid tag comprising a chemical reaction site is treated with the NHS ester of FMOC-alanine in DMF. The FMOC protecting group is removed with piperidine to provide an alanine coupled to the chemical reaction site of the nucleic acid tag. The process can be repeated many times, and with a variety of amino acids at successive steps in order to produce a library of distinct polypeptides.

FIGS. 3A-3D illustrate a method of partition based chemical synthesis using a series of columns to generate a library of distinct chemical compounds.

FIG. 4 schematically illustrates a capture template molecule with an optional linker or secondary capture template.

FIG. 5 schematically illustrates a capture template molecule with an attached linker, hybridized to a coding template where the linker is attached to a solid support, such as, for example, a bead.

FIG. 6 schematically illustrates a capture template molecule, which is hybridized to a coding template, with an attached secondary capture template hybridized to a complementary oligonucleotide attached to a solid support, such as, for example, a bead.

FIG. 7 schematically illustrates a macro capture template with an attached biological label with capture templates separated by linkers or secondary capture templates.

FIG. 8 schematically illustrates a macro capture template, with an attached biological label, where individual capture templates are separated by linkers or secondary capture template and are hybridized to coding templates.

FIG. 9 schematically illustrates a macro capture template, with an attached biological label, where the individual capture templates are separated by linkers or secondary capture templates and are hybridized to coding templates. The attached label of the macro capture template forms a complex with a biological agent attached to a solid support, such as, for example, a bead.

FIG. 10 schematically illustrates a macro capture template where the individual capture templates are separated by a secondary capture template or linkers.

FIG. 11 schematically illustrates a macro capture template where the individual capture templates are separated by secondary capture templates and the capture templates are hybridized to coding templates.

FIG. 12 schematically illustrates a macro capture template where capture templates are separated by secondary capture templates and the capture templates are hybridized to coding templates. The secondary capture templates are hybridized to complementary oligonucleotides attached to a solid support.

FIG. 13 schematically illustrates multiple macro capture templates attached to a dendrimer, where the individual capture templates are separated by secondary capture templates or linkers.

FIG. 14 schematically illustrates multiple macro capture templates attached to a dendrimer, where the individual capture templates are separated by secondary capture templates where the capture templates are hybridized to coding templates.

FIG. 15 schematically illustrates multiple macro capture templates attached to a dendrimer where the capture templates are hybridized to coding templates and the secondary capture template are hybridized to complementary oligonucleotides attached to a solid support.

FIG. 16 schematically illustrates multiple macro capture templates attached to a dendrimer, where the individual capture templates are separated by a linker, where the capture templates are hybridized to coding templates and at least one secondary capture template attached to the dendrimer is hybridized to complementary oligonucleotides attached to a solid support.

### DETAILED DESCRIPTION

### Definitions

Unless defined otherwise, all technical and scientific terms used herein have the same meaning as is commonly understood by one of ordinary skill in the art to which this invention belongs. If a plurality of definitions for a term exists, those in this section prevail unless stated otherwise.

It must be noted that as used herein and in the appended claims, the singular forms “a”, “an” and “the” include plural referents unless the context clearly dictates otherwise. Thus, for example, reference to “a tag” includes a plurality of such tags and reference to “the compound” includes reference to one or more compounds and equivalents thereof known to those skilled in the art, and so forth.

It is further noted that the claims may be drafted to exclude any optional element. As such, this statement is intended to serve as antecedent basis for use of such exclusive terminology as “solely”, “only” and the like in connection with the recitation of claim elements or the use of a “negative” limitation.

As used herein, and unless otherwise specified, the terms “about” and “approximately,” when used in connection with a property with a numeric value or range of values indicate that the value or range of values may deviate to an extent deemed reasonable to one of ordinary skill in the art while still describing the particular property. Specifically, the terms “about” and “approximately,” when used in this context, indicate that the numeric value or range of values may vary by 5%, 4%, 3%, 2%, 1%, 0.9%, 0.8%, 0.7%, 0.6%, 0.5%, 0.4%, 0.3%, 0.2% or 0.1% of the recited value or range of values while still describing the particular solid form.

“Antibody” as used herein refers to a protein comprising one or more polypeptides substantially or partially encoded by immunoglobulin genes or fragments of immunoglobulin genes, e.g., a fragment containing one or more complementarity determining region (CDR). The recognized immunoglobulin genes include the kappa, lambda, alpha, gamma, delta, epsilon and mu constant region genes, as well as myriad immunoglobulin variable region genes. Light chains are typically classified as either, e.g., kappa or lambda. Heavy chains are typically classified e.g., as gamma, mu, alpha, delta, or epsilon, which in turn define the immunoglobulin classes, IgG, IgM, IgA, IgD and IgE, respectively. A typical immunoglobulin (antibody) structural unit comprises a tetramer. In nature, each tetramer is composed of two identical pairs of polypeptide chains, each pair having one “light” (about 25 kD) and one “heavy” chain (about 50-70 kD). The N-terminus of each chain defines a variable region of about 100 to 110 or more amino acids primarily responsible for antigen recognition. The terms variable light chain (VL) and variable heavy chain (VH) refer to these light and heavy chains respectively. Antibodies exist as intact immunoglobulins or as a number of well characterized fragments produced by digestion with various peptidases. Thus, for example, pepsin digests an antibody below the disulfide linkages in the hinge region to produce F(ab)′2 (fragment antigen binding) and Fc (fragment crystallizable, or fragment complement binding). F(ab)′2 is a dimer of Fab, which itself is a light chain joined to VH-CH 1 by a disulfide bond. The F(ab)′2 may be reduced under mild conditions to break the disulfide linkage in the hinge region thereby converting the (Fab′)₂ dimer into a Fab′ monomer. The Fab′ monomer is essentially a Fab with part of the hinge region. The Fc portion of the antibody molecule corresponds largely to the constant region of the immunoglobulin heavy chain, and is responsible for the antibody's effector function (see, Fundamental Immunology, 4^{th} edition. W. E. Paul, ed., Raven Press, N.Y. (1998), for a more detailed description of antibody fragments). While various antibody fragments are defined in terms of the digestion of an intact antibody, one of skill will appreciate that such Fab′ or Fc fragments may be synthesized de novo either chemically or by utilizing recombinant DNA methodology, peptide display, or the like. Thus, the term antibody, as used herein, also includes antibody fragments either produced by the modification of whole antibodies or synthesized de novo using recombinant DNA methodologies. Antibodies also include single-armed composite monoclonal antibodies, single chain antibodies, including single chain Fv (sFv) antibodies in which a variable heavy and a variable light chain are joined together (directly or through a peptide linker) to form a continuous polypeptide, as well as diabodies, tribodies, and tetrabodies (Pack et al., (1995) J Mol Biol 246:28; Biotechnol 11:1271; and Biochemistry 31:1579). The antibodies are, e.g., polyclonal, monoclonal, chimeric, humanized, single chain, Fab fragments, fragments produced by a Fab expression library, or the like.

“Base-specific duplex formation” or “hybridization” as used herein refer to temperature, ionic strength and/or solvent conditions effective to produce sequence-specific pairing between a single-stranded oligonucleotide and its complementary-sequence nucleic acid strand, for a given length oligonucleotide. Such conditions are preferably stringent enough to prevent or largely prevent hybridization of two nearly-complementary strands that have one or more internal base mismatches. In some embodiments, the region of identity between two sequences forming a base-specific duplex is greater than about 5 base pairs. In other embodiments, the region of identity is greater than about 10 base pairs.

“Capture template” as used herein refers to a polymer capable of recognizing nucleic acid sequences. In general, a capture template is complementary to one of the different hybridization sequences (e.g., a₁, b₁, c₁, etc.) of the coding templates and therefore allows for sequence-specific splitting of a population of coding templates into a plurality of sub-populations of distinct coding templates in separate spatial locations. In some embodiments, the capture template will possess about the same number of nucleotides as the hybridization sequence of a coding template. However, as is known to those of skill in the art the capture template may be smaller or larger than the hybridization sequence of a coding template as long as hybridization between the coding template and capture template is sufficient. In some embodiments, capture templates are attached to solid supports. Capture templates may be oligonucleotides, constrained nucleosides, bridged nucleosides, locked nucleic acids, constrained ethyl nucleosides, single stranded RNAs, single stranded DNAs, DNA binding proteins, RNA binding proteins, peptide nucleic acids, a peptide, a depsipeptide, a polypeptide, an antibody, a peptoid or a polymer. In some embodiments, capture template are oligonucleotides, L-nucleic acids, peptide nucleic acids, single stranded RNAs or single stranded DNAs. In other embodiments, capture templates are oligonucleotides.

“Coding template” as used herein refers to nucleic acid sequences which each comprise a plurality of hybridization sequences (i.e., codons) and a functional group or a linking entity. Coding templates may be oligonucleotides, constrained nucleosides, bridged nucleosides, locked nucleic acids, constrained ethyl nucleosides, single stranded RNAs or single stranded DNAs. The “hybridization sequences” refer to oligonucleotides comprising between about 3 and up to 100, 3 and up to 50, and from about 5 to about 30 nucleic acid subunits. Such coding templates can direct the synthesis of the combinatorial library based on the catenated hybridization sequences. The coding template is operatively linked to a functional group or optionally a linking entity. Coding templates may be immobilized by capture templates and direct combinatorial library synthesis in DPCC. In some embodiments, coding templates are invariant during DPCC.

“Combinatorial library” as used herein refers to a library of molecules containing a large number, typically between about 10³ and about 10¹⁵ or more different compounds typically characterized by different sequences of subunits, or a combinations of different side chains functional groups and linkages.

“Depsipeptide” as used herein refers to a peptide as defined herein where one or more of amide bonds are replaced by ester bonds.

“Functional group” as used herein, refers to a chemical group such as, for example, an electrophilic group, a nucleophilic group, a diene, a dienophile, etc. Examples of functional groups include, but are not limited to, —NH₂, —SH, —OH, —CO₂H, halo, —N₃, —CONH₂, etc. and may also include dendrimers with the above functional groups. The functional group may be attached an intermediate in the synthesis of a ligand of a combinatorial library.

“Label” as used herein, is an identifier which is attached to a capture template or a macro capture template. The label may be attached through a linker to the capture template or a macro capture template. Examples of labels include antibody substrates, antibodies, irreversible receptor binders, receptors, irreversible enzyme inhibitors, enzymes, biotin, avidin, streptavidin, etc. A characteristic of such labels includes formation of a complex with a complementary agent, which in some embodiments, is irreversible. As such, the above list is illustrative rather than comprehensive.

“Ligand” as used herein refers to an oligonucleotide, constrained nucleosides, bridged nucleosides, locked nucleic acids, constrained ethyl nucleosides, single stranded RNA, single stranded DNA, a DNA binding protein, a RNA binding protein, a peptide nucleic acid, a peptide, a depsipeptide, a polypeptide, an antibody, a peptoid, a polymer, a polysiloxane, an inorganic compound of molecular weight greater that 50 daltons, an organic compound of molecular weight of less than about 1500 daltons.

“Linking entity” as used herein, refers to a molecule which is operatively linked to a coding template and which in most embodiments includes at least one functional group. The functional group of the linking entity, in some instances, serves as the initiation site for commencing ligand synthesis. In still other instances, the linking entity may be a functional group attached to an intermediate in ligand synthesis. In still other instances, the linking entity may be a ligand, which may contain a functional group attached a linker. In other instances, the functional group of the linking entity may be the site for connecting to another linking entity or a dendrimer. In some embodiments, the functional group of the linking entity may be protected, by methods well known to those of skill in the art. The linking entity may vary in structure and length. The linking entity may be hydrophobic or hydrophilic, long or short, rigid, semirigid or flexible, etc. The linking entity can comprise, for example, a polymethylene chain, such as a —(CH₂)ₙ— chain or a poly(ethylene glycol) chain, such as a —(CH₂CH₂O)ₙ chain, where in both cases n is an integer from 1 to about 40, 5′-O-Dimethoxytrityl-1′,2′-Dideoxyribose-3′-[(2-cyanoethyl)-(N,N-diisopropyl)]-phosphoramidite; 9-O-Dimethoxytrityl-triethylene glycol, 1-[(2-cyanoethyl)-(N,N-diisopropyl)]-phosphoramidite; 3-(4,4′-Dimethoxytrityloxy)propyl-1-[(2-cyanoethyl)-(N,N-diisopropyl)]-phosphoramidite; and 18-O-Dimethoxytritylhexaethyleneglycol, 1,-[(2-cyanoethyl)-(N,N-diisopropyl)]-phosphoramidite, amino-carboxylic linkers (e.g., peptides (e.g., Z-Gly-Gly-Gly-Osu or Z-Gly-Gly-Gly-Gly-Gly-Gly-Osu), PEG (e.g., Fmoc-aminoPEG2000-NHS or amino-PEG (12-24)-NHS), or alkane acid chains (e.g., Boc-ε-aminocaproic acid-Osu)), click chemistry linkers (e.g., peptides (e.g., azidohomalanine-Gly-Gly-Gly-OSu or propargylglycine-Gly-Gly-Gly-OSu), PEG (e.g., azido-PEG-NHS), or alkane acid chains (e.g., 5-azidopentanoic acid, (S)-2-(azidomethyl)-1-Boc-pyrrolidine, or 4-azido-butan-1-oic acid N-hydroxysuccinimide ester)), thiol-reactive linkers (e.g., PEG (e.g., SM(PEG)n NHS-PEG-maleimide), alkane chains (e.g., 3-(pyridin-2-yldisulfanyl)-propionic acid-Osu or sulfosuccinimidyl 6-(3′-[2-pyridyldithio]propionamido)hexanoate))), amidites for oligonucleotide synthesis (e.g., amino modifiers (e.g., 6-(trifluoroacetylamino)-hexyl-(2-cyanoethyl)-(N,N-diisopropyl)-phosphoramidite), thiol modifiers (e.g., S-trityl-6-mercaptohexyl-1-[(2-cyanoethyl)-(N,N-diisopropyl)]-phosphoramidite, or chick chemistry modifiers (e.g., 6-hexyn-1-yl-(2-cyanoethyl)-(N,N-diisopropyl)-phosphoramidite, 3-dimethoxytrityloxy-2-(3-(3-propargyloxypropanamido)propanamido)propyl-1-O-succinoyl, long chain alkylamino CPG, or 4-azido-butan-1-oic acid N-hydroxysuccinimide ester)). In some embodiments, the linking entity may include a functionalized dendrimer which are available from a number of commercial suppliers such as, for example, Sigma Aldrich, ST. Louis, Mo., Polymer Factory Sweden AB, Teknikringen 48, SE-114, 28 Stockholm, Sweden, Dendritech, Inc. 3110 Schuette Rd., Midland, Mich., 48642 or NanoSynthons LLC, 1200 N. Facher Ave., Mt. Pleasant, Mich. 48858. The dendrimer may be, for example, a PANAM dendrimer or polypropylenimine dendrimer.

“Linker” as used herein, is any molecule or substance which links one capture template to another capture template to form a macro capture template. The linker may vary in structure and length. The linker may be hydrophobic or hydrophilic, long or short, rigid, semirigid or flexible, etc. The linker can comprise, for example, a constant oligonucleotide, a polymethylene chain, such as a —(CH₂)— chain or a poly(ethylene glycol) chain, such as a —(CH₂CH₂O) chain, where in both cases n is an integer from 1 to about 40, 5′-O-Dimethoxytrityl-1′,2′-Dideoxyribose-3′-[(2-cyanoethyl)-(N,N-diisopropyl)]-phosphoramidite; 9-O-Dimethoxytrityl-triethylene glycol,1-[(2-cyanoethyl)-(N,N-diisopropyl)]-phosphoramidite; 3-(4,4′-Dimethoxytrityloxy)propyl-1-[(2-cyanoethyl)-(N,N-diisopropyl)]-phosphoramidite; and 18-O-Dimethoxytritylhexaethyleneglycol, 1,-[(2-cyanoethyl)-(N,N-diisopropyl)]-phosphoramidite, amino-carboxylic linkers (e.g., peptides (e.g., Z-Gly-Gly-Gly-Osu or Z-Gly-Gly-Gly-Gly-Gly-Gly-Osu), PEG (e.g., Fmoc-aminoPEG2000-NHS or amino-PEG (12-24)-NHS), or alkane acid chains (e.g., Boc-ε-aminocaproic acid-Osu)), click chemistry linkers (e.g., peptides (e.g., azidohomalanine-Gly-Gly-Gly-OSu or propargylglycine-Gly-Gly-Gly-OSu), PEG (e.g., azido-PEG-NHS), or alkane acid chains (e.g., 5-azidopentanoic acid, (S)-2-(azidomethyl)-1-Boc-pyrrolidine, or 4-azido-butan-1-oic acid N-hydroxysuccinimide ester)), thiol-reactive linkers (e.g., PEG (e.g., SM(PEG)n NHS-PEG-maleimide), alkane chains (e.g., 3-(pyridin-2-yldisulfanyl)-propionic acid-Osu or sulfosuccinimidyl 6-(3′-[2-pyridyldithio]propionamido)hexanoate))), amidites for oligonucleotide synthesis (e.g., amino moxlifiers (e.g., 6-(trifluoroacetylamino)-hexyl-(2-cyanoethyl)-(N,N-diisopropyl)-phosphoramidite), thiol modifiers (e.g., S-trityl-6-mercaptohexyl-1-[(2-cyanoethyl)-(N,N-diisopropyl)]-phosphoramidite, or chick chemistry modifiers (e.g., 6-hexyn-1-yl-(2-cyanoethyl)-(N,N-diisopropyl)-phosphoramidite, 3-dimethoxytrityloxy-2-(3-(3-propargyloxypropanamido)propanamido)propyl-1-O-succinoyl, long chain alkylamino CPG, or 4-azido-butan-1-oic acid N-hydroxysuccinimide ester)). The linker, in some embodiments, may be a dendrimer or a nucleic acid.

“Macro capture template” as used herein refers to nucleic acid molecules of between about 500 and 25,000 nucleic acid subunits which include one or more identical capture templates. The macro capture template includes one or more secondary capture templates or one or more linkers or combinations thereof. The secondary capture templates or linkers may be randomly interspersed between capture templates or may be used to separate capture template units.

“Nucleic acid” as used herein refers to an oligonucleotide analog as defined below as well as a double stranded or single stranded DNA and RNA molecule. A DNA and RNA molecule may include the various analogs defined below.

“Oligonucleotides” or “oligos” as used herein refer to nucleic acid oligomers containing between about 3 and up to about 500 typically from about 5 to about 250, from about 3 to about 100 or from about 3 to 50 nucleic acid subunits. In the context of oligos (e.g., hybridization sequence) which may direct the synthesis of library compounds, the oligos may include or be composed of naturally-occurring nucleotide residues, nucleotide analog residues, or other subunits capable of forming sequence-specific base pairing, when assembled in a linear polymer, with the proviso that the polymer is capable of providing a suitable substrate for strand-directed polymerization in the presence of a polymerase and one or more nucleotide triphosphates, e.g., conventional deoxyribonucleotides. A “known-sequence oligo” is an oligo whose nucleic acid sequence is known. Oligonucleotides include nucleic acids that have been modified and which are capable of some or all of the chemical or, biological activities of the oligonucleotide from which it was derived. An oligonucleotide analog will generally contain phosphodiester bonds, although in some cases, oligonucleotide analogs are included that may have alternate backbones. Modifications of the ribose-phosphate backbone may facilitate the addition of additional moieties such as labels, or may be done to increase the stability and half-life of such molecules. In addition, mixtures of naturally occurring nucleic acids and analogs can be made. Alternatively, mixtures of different nucleic acid analogs, and mixtures of naturally occurring nucleic acids and analogs may be made. The oligonucleotides may be single stranded or double stranded, as specified, or contain portions of both double stranded or single stranded sequence. The oligonucleotide may be DNA, RNA or a hybrid, where the nucleic acid contains any combinations of deoxyribo- and ribo-nucleotides, and any combinations of bases, including uracil, adenine, thymine, cytosine, guanine, inosine, xathanine, hypoxathanine, isocytosine, isoguanine, etc.

“Peptide” as used herein refers to a polymer of amino acid residues between about 2 and 50 amino acid residues, between about 2 and 20 amino acid residues, or between about 2 and 10 residues. Peptides include modified peptides such as, for example, glycopeptides, PEGylated peptides, lipopeptides, peptides conjugated with organic or inorganic ligands, peptides which contain peptide bond isosteres (e.g., ψ[CH₂S], ψ[CH₂NH₂], ψ[NHCO], ψ[COCH₂], ψ[(E) or (Z) CH═CH], etc. and includes cyclic peptides. In some embodiments, the amino acid residues may be any L-α-amino acid, D-α-amino residue, N-alkyl variants thereof or combinations thereof. In other embodiments, the amino acid residues may any L-α-amino acid, D-α-amino residue, β-amino acids, i-amino acids, N-alkyl variants thereof or combinations thereof.

“Operatively linked,” as used herein, means at least two chemical structures joined together in such a way as to remain linked through the various manipulations described herein. Typically, a ligand or functional group and the coding template are linked covalently via an appropriate linker. The linker is at least a bivalent moiety with a site of attachment for the oligonucleotide and a site of attachment for the ligand or a functional group. For example, when the functional moiety is a polyamide compound, the polyamide compound can be attached to the linking group at the N-terminus, the C-terminus or via a functional group on one of the side chains. The linker is sufficient to separate the ligand and the coding template by at least one atom and in some embodiments by more than one atom. In most embodiments, the linker is sufficiently flexible to allow the ligand to bind target molecules in a manner which is independent of the coding template.

“Peptide nucleic acid” as used herein refers to oligonucleotide analogues where the sugar phosphate backbone of nucleic acids has been replaced by pseudopeptide skeleton (e.g., N-(2-aminoethyl)-glycine, Nielsen et al., U.S. Pat. No. 5,539,082; Nielsen et al., U.S. Pat. No. 5,773,571; Burchardt et al., U.S. Pat. No. 6,395,474).

“Peptoid” as used herein refers to polymers of poly N-substituted glycine (Simon et al., Proc. Natl. Acad. Sci. (1992) 89(20) 9367-9371) and include cyclic variants thereof.

“Polypeptide” as used herein refers to a polymer of amino acid residues typically comprising greater than 50 amino acid residues and includes cyclic variants thereof. Polypeptide includes proteins (including modified proteins such as glycoproteins, PEGylated proteins, lipoproteins, polypeptide conjugates with organic or inorganic ligands, etc.) receptor, receptor fragments, enzymes, structural proteins (e.g., collagen) etc. In some embodiments, the amino acid residues may be any L-α-amino acid, D-α-amino residue, or combinations thereof. In other embodiments, the amino acid residues may be any L-α-amino acid, D-α-amino residue, N-alkyl variants thereof or combinations thereof.

“Polymer” as used herein includes copolymers, and the term “monomer” includes co-monomers. Polymers include, for example, polyamides, phospholipids, polycarbonates, polysaccharides, polyurethanes, polyesters, polyureas, polyacetates, polyarylene sulfides, polyethylenimines, polyimides, etc.

“Secondary capture template” as used herein refers to a nucleic acid sequence included in a macro capture template which is complementary to a nucleic acid sequence attached, in some embodiments, to an immobilized support, such as, for example, beads resins, glass slides, filter paper or microfluidic devices. In general, a secondary capture template is complementary to one of the different hybridization sequences of a complementary oligonucleotides attached to a solid support and therefore allows for sequence-specific splitting of a population of coding templates into a plurality of sub-populations of distinct coding templates in separate spatial locations. In general, the number of different secondary capture template sequences will be equivalent to the number of coding template sequences. The secondary capture template may possess about the same number of nucleotides as the hybridization sequence of a coding template. However, as is known to those of skill in the art the secondary capture template may be smaller or larger than the hybridization sequence of the complementary nucleotide as long as hybridization between the secondary capture template and complementary oligonucleotide is sufficient. Secondary capture templates may be oligonucleotides, constrained nucleosides, bridged nucleosides, locked nucleic acids, constrained ethyl nucleosides, single stranded RNAs, single stranded DNAs, DNA binding proteins, RNA binding proteins, peptide nucleic acids, a peptide, a depsipeptide, a polypeptide, an antibody, a peptoid or a polymer. In some embodiments, capture template are oligonucleotides, L-nucleic acids, peptide nucleic acids, single stranded RNAs or single stranded DNAs. In other embodiments, capture templates are oligonucleotides.

“Solid support” as used herein refers to, for example, beads (e.g., magnetic, colored, porous and non-porous), resins (Sepharose, agarose, DEAE, polystyrene, etc.), glass slides, filter paper or microfluidic devices. Other solid supports not explicitly mentioned are within the scope of the present disclosure.

“Spatially localized” as used herein means a unique isolated spatial location. An example of a spatially localized substance are magnetic beads with identical attached capture templates in a discrete well of a well-plate. Another example of a spatially localized substance is uniquely colored beads with identical attached capture templates hybridized to complementary coding templates in a discrete well of a well-plate.

Reference will now be made in detail to embodiments of the invention. While the invention will be described in conjunction with these embodiments, it will be understood that it is not intended to limit the invention to the embodiments, infra. To the contrary, it is intended to cover alternatives, modifications, and equivalents as may be included within the spirit and scope of the invention as defined by the appended claims.

### Methods of Routing

While not wishing to be bound by theory, routing or fractionation of coding templates generally can proceed by two distinct procedures. In a first procedure, coding templates are fractionated by capture templates and/or macro capture templates that are spatially localized a priori. The mixture of coding templates is contacted with capture templates and/or macro capture templates either sequentially or continuously to localize the individual coding templates in discrete spatial locations as part of a complex with capture templates and/or macro capture templates. In a second procedure, the coding templates are contacted with capture templates and/or macro capture templates in a batch process. The capture templates and/or macro capture templates may be attached to solid supports where the solid support with the attached complex of coding template hybridized to capture templates and/or macro capture templates is fractionated or sorted on the basis of size, color, etc. of the support. Here, if the support is of sufficient macroscopic size, then a number of supports with attached capture templates and/or macro capture templates, equal to the number of coding templates can be mixed with coding templates and then placed in separate spatial locations manually. Alternatively, a mixture of complexes including coding templates and capture templates and/or macro capture templates can be fractioned by chromatographic means and or gel electrophoresis. In still other methods, capture templates and/or macro capture templates can be barcoded and the complex of coding templates with capture templates and/or macro capture templates resolved on the basis of the barcode (e.g., by hybridization or other physical properties of the bar code). In still other methods, each capture template and/or macro capture template can differ in size and the complex of coding templates with capture templates and/or macro capture templates be resolved by electrophoretic or chromatographic means including, for example, size exclusion chromatography.

Accordingly, provided herein are methods for routing mixtures of coding templates to n spatial locations, which may be used, inter alia, in DNA Programmed Combinatorial Chemistry (DPCC) to provide complex combinatorial libraries. The combinatorial libraries may include ligands which bind to important biological targets (Harbury et al., U.S. Pat. No. 7,479,472; Harbury et al., U.S. Patent Application No. 2006/0099626; Wrenn et al., J. Am. Chem. Soc. 129(43), 13137, 2007; Weisinger et al., PLOS One, e28056, 2012; Halpin et al., PLOS One, 1015, 2004; Halpin et al., PLOS One, 1022, 2004; Halpin et al., PLOS One, 1031, 2004; Glokler et al., International Publication No. WO 2012/004204). The methods described herein use capture templates and/or macro-capture templates to route different polymers (i.e., coding templates) and/or the properties of solid supports to unique spatial locations, which is important for polymer directed synthesis of small molecule combinatorial chemistry libraries.

Described below in greater detail are some coding templates used for producing small-molecule combinatorial libraries. It should be apparent to the skilled artisan that many different types of coding templates may be envisioned. Accordingly, the below description is meant to be illustrative rather than comprehensive and the invention is not limited to the coding templates described below.

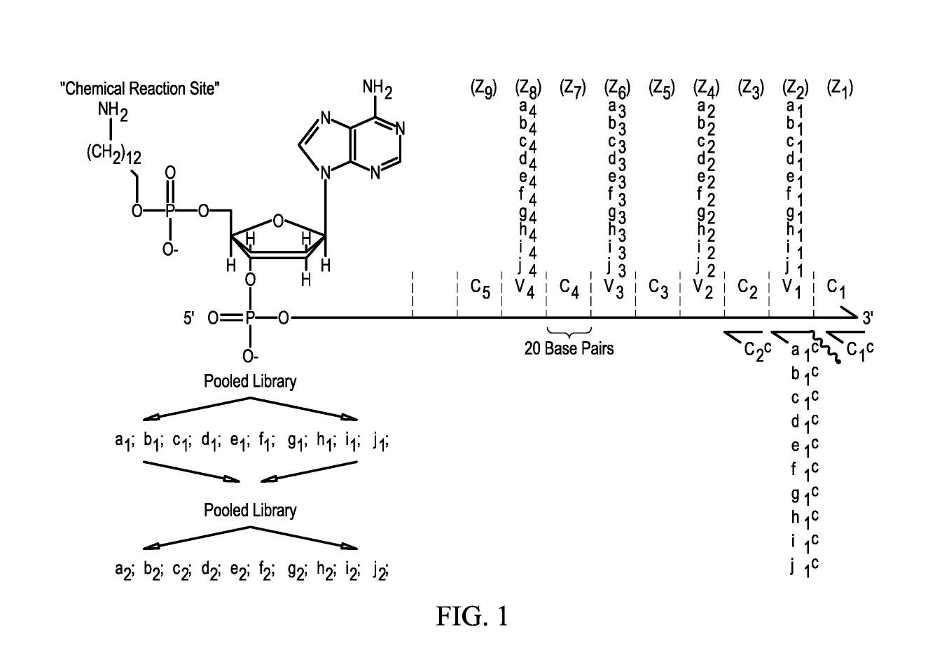

Coding templates are compounds having a nucleic acid sequence including at least one, typically two or more different catenated hybridization sequences, optional constant spacer sequences and an attached linking entity or functional group (i.e., chemical reaction moiety) (FIG. 1). Coding templates are not limited in the number of hybridization sequences and/or constant spacer sequences. The hybridization sequences in any given coding template generally differ from the sequences in any other coding template. It should be noted that different coding templates can share a common codon. The hybridization sequences of each coding template identify the particular chemical compounds used in each successive synthesis step for synthesizing a unique ligand attached to the linking entity or functional group. As such, hybridization sequences of each coding template also identify the order of attachment of the particular chemical units to the linking entity or functional group.

In general, each hybridization sequence of a coding template provides a separate sequence for hybridizing to a complementary capture or macro capture template. The different hybridization sequences of the coding templates enable sequence-specific splitting of a population of coding templates into a plurality of sub-populations of distinct coding templates. Each sub-population of coding templates may then be reacted with distinct chemical subunits to couple the distinct chemical subunit to the functional group of the linking entity or functional group.

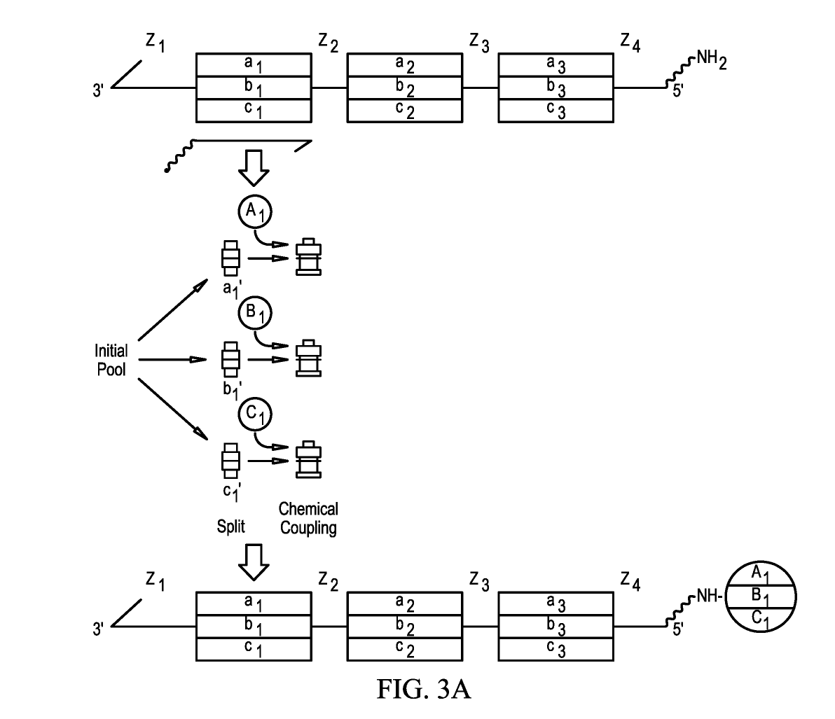

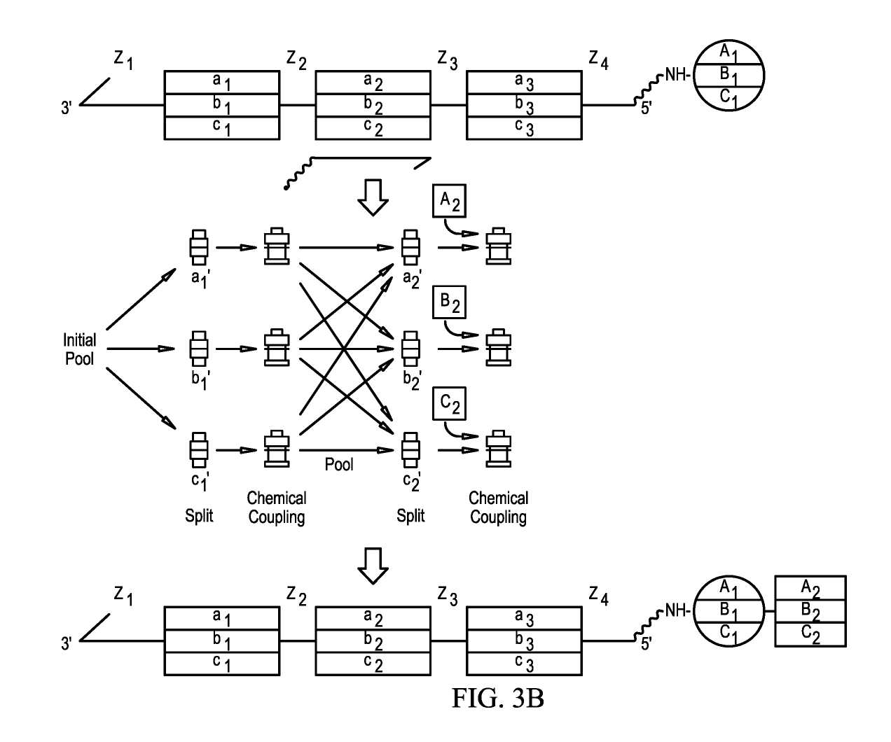

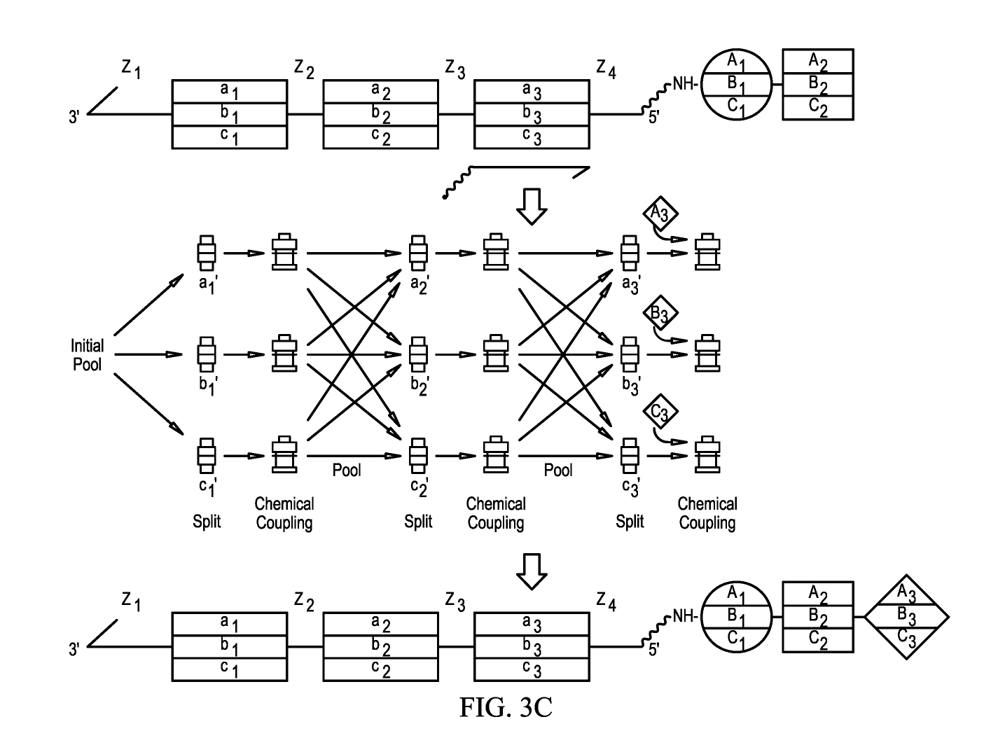

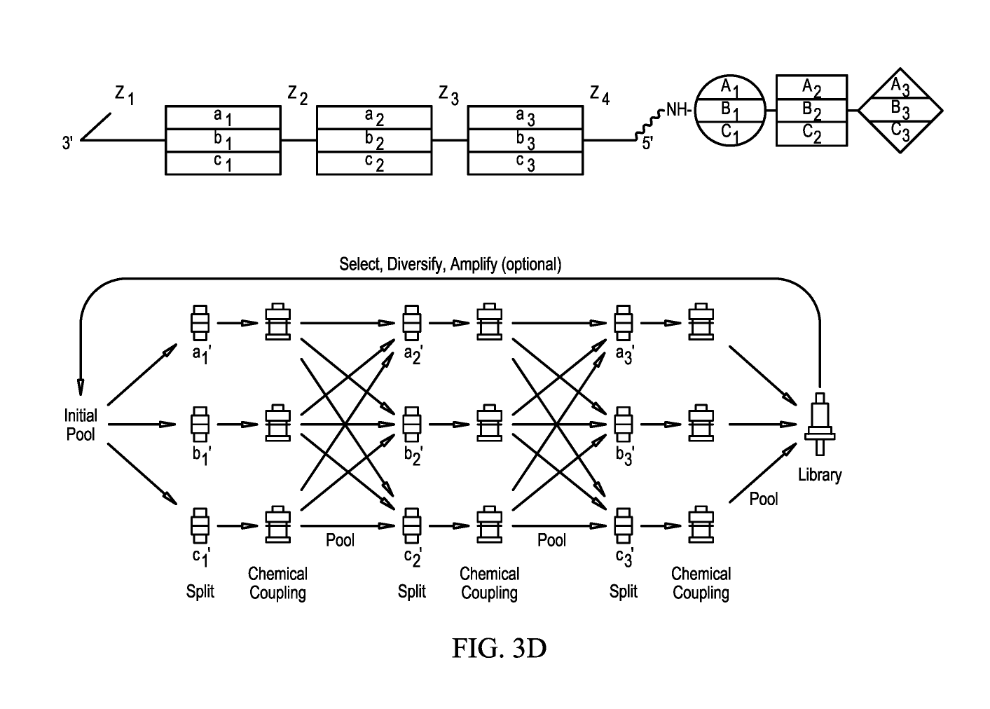

To carry out a first reaction step, the population of coding templates is split into a plurality of sub-populations of distinct coding templates, e.g., 10 different sub-populations corresponding to the ten different hybridization sequences at the “first” position (V₁, e.g., a₁, b₁, or c₁) in each coding template (FIG. 3A, top and middle panels). This is done, for example, by contacting the coding templates with a first group of capture templates and/or macro capture templates with sequences complementary to one of the different “first-position” hybridization sequences in the coding template (e.g., a₁′, b₁′, or c₁′): The contacting step provides for dividing a population of coding templates into X₁ sub-populations (where X represents the number of different capture templates and/or macro-capture templates used to separate the pooled coding templates), where each sub-population of capture templates and/or macro-capture templates shares at least one common hybridization sequence with the coding template.

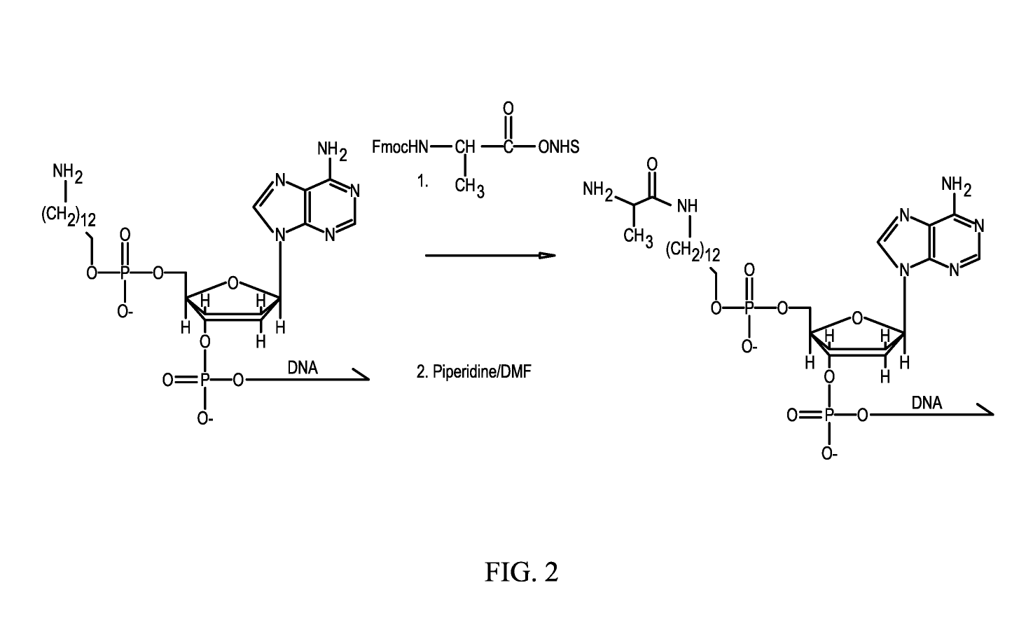

After the first splitting step, the X₁ different coding template sub-populations, (e.g., ten different sub-populations of coding templates as exemplified in FIG. 3A) are reacted with X₁ different chemical subunits (FIG. 3A, middle panel). The reactions are performed such that the identity of each chemical subunit used in the coupling step is directed by the particular first position hybridization sequence of the coding template in the sub-population. As exemplified in FIG. 3A, the chemical subunits A₁, B₁, or C₁ corresponds to the particular coding template hybridization sequence in the first position (e.g., a₁, b₁, or c₁). The first chemical coupling step converts the functional group of the linking entity or functional group in each coding template to a reagent-specific compound intermediate, by conjugating the particular chemical subunits to functional group of the linking entity or functional group of each coding template sub-population (e.g., A₁, B₁, or C₁, as exemplified in FIG. 2). The result is N₁ different sub-populations of coding templates, each sub-population having a different chemical subunit with a functional group attached to each coding template sub-population (FIG. 3A, bottom panel). For example, three different populations of coding templates (as separated by hybridization to a₁, b₁, or c₁ in the split step) are represented in the bottom panel of FIG. 3A, where a first sub-population of coding templates separated by the a₁ sequence is modified to contain the chemical subunit A₁, a second sub-population of molecules separated by the b₁ sequence is modified to contain the chemical subunit B₁, and a third sub-population of molecules separated by the c₁ sequence is modified to contain the chemical subunit C₁. In each instance, a chemical subunit is coupled to the functional group of the linking entity or functional group of the coding template where the added chemical subunit provides the functional group of the linking entity or functional group for coupling of an additional subunit in a subsequent step as desired.

Following the first splitting and chemical coupling steps, the X₁ coding template sub-populations are pooled and contacted with a second group of reagents (capture templates and/or macro-capture templates, e.g., a₂′, b₂′, or c₂′), each having a sequence that is complementary to one of the X₂ different second-position hybridization sequences of the coding templates (e.g., a₂, b₂, or c₂) (FIG. 3B, top and middle panels). As a result, the pooled population of coding templates is split into a plurality of X₂ sub-populations of distinct coding templates. The number of sub-populations in the second step (X₂) may be the same or different than the number of sub-populations resulting from the first stage split (X₁). As above, each sub-population of coding templates are determined by the “second-position” hybridization sequence of the coding templates (e.g., a₂, b₂, or c₂) (FIG. 3B, middle panel).

Each of the different “second-position” sub-populations of coding template is then reacted with one of a second plurality of chemical subunits, a different chemical subunit for each subset (e.g., A₂, B₂, or C₂) (FIG. 3B, middle panel). The result is a X₂ different sub-populations of coding templates, each population having a different chemical subunit conjugated to the previous chemical subunit of each coding template (FIG. 3B, bottom panel). For example, as exemplified in the bottom panel of FIG. 3B, nine different sub-populations of coding templates can be generated, where a first population comprises the chemical subunits A₁ and A₂, a second population comprises the chemical subunits A₁ and B₂, a third population comprises the chemical subunits A₁ and C₂, a fourth population comprises the chemical subunits B₁ and A₂, a fifth population comprises the chemical subunits B₁ and B₂, a sixth population comprises the chemical subunits B₁ and C₂, a seventh population comprises the chemical subunits C₁ and A₂, an eighth population comprises the chemical subunits C₁ and B₂, and a ninth population comprises the chemical subunits C₁ and C₂.

This process of splitting the previously reacted coding templates into X different sub-population (where X represents the number of different capture sequences used to separate the pooled compounds and n represents the step number of the synthetic scheme) can be repeated as desired. For example, as illustrated in FIGS. 3C and 3D, the coding templates can be hybridized with a new set of capture templates and/or macro-capture templates, then reacting the Xₙ separated sub-populations of coding templates with Xₙ different selected chemical subunits. These steps can be repeated until all of the desired reaction steps are performed successively on the reaction sites of the coding templates (FIG. 3C and FIG. 3D). The result is a combinatorial library of X₁×X₂× . . . ×X_{N} different coding templates wherein the particular of hybridization sequences at the N positions (e.g., V₁, V₂, and V₃, see FIG. 1) of the coding templates dictates the sequence of chemical subunits of the resultant attached ligand.

As exemplified in the top panel of FIG. 3D, twenty-seven different populations of coding templates can be generated from the steps as exemplified in FIGS. 3A-3C. The exemplary combinatorial library of ligands includes, for example, a first population comprising the chemical subunits A₁, A₂, and A₃, a second population comprising the chemical subunits A₁, B₂, and A₃, a third population comprising the chemical subunits A₁, C₂, and A₃, a fourth population comprising the chemical subunits B₁, A₂, and A₃, a fifth population comprising the chemical subunits B₁, B₂, and A₃, a sixth population comprising the chemical subunits B₁, C₂, and A₃, a seventh population comprising the chemical subunits C₁, A₂, and A₃, an eighth population comprising the chemical subunits C₁, B₂, and A₃, and a ninth population comprising the chemical subunits C₁, C₂, and A₃, etc.

As exemplified in FIG. 1, the coding template is composed of Zₙ (e.g., n=9) regions of different catenated nucleic acid sequences and a linking entity or functional group. Five of these regions are denoted C₁ through C₅ and refer to the “constant” or “spacer” sequences that are the same for the coding template. The four remaining Z regions are denoted V₁ through V₄ and refer to the “variable” hybridization sequences at the first through fourth positions. In representative embodiments, the V regions and C regions alternate in order from the 3′ end of the nucleic acid tag to the 5′ end of the nucleic acid tag. In certain embodiments, the first Z region is a C region. In other embodiments, the first Z region is a V region. In certain embodiments, the last Z region is a C region. In other embodiments, the last Z region is a V region.

The variable hybridization sequences are generally different for each group of sub-population coding templates at each position. In this embodiment, every V region is bordered by two different C regions. As will be appreciated from below, all of the V-region sequences are orthogonal, such that no two V-region sequences cross-hybridize with each other. For example, in an embodiment that comprises coding templates that include four variable regions and 400 different nucleic acid sequences for each of the four variable regions, there are a total of 1.600 orthogonal nucleic acid hybridization sequences. Such hybridization sequences can be designed according to known methods. For example, where each variable hybridization sequence comprises 20 nucleotides, with a possibility of one of four nucleotides at each position, 4²⁰ different sequences are possible. Of the different possible candidates, specific sequences can be elected such that each sequence differs from another sequence by at least 2 to 3, or more, different internal nucleotides.

In some embodiments, suitable C and V regions comprise from about 8 and about 50 nucleotides including from about 12 and about 40 nucleotides, from about 10 nucleotides to about 30 nucleotides in length. In other embodiments, C and V regions comprise from about 11 nucleotides to about 29 nucleotides in length, including from about 12 to about 28, from about 13 to about 27, from about 14 to about 26, from about 14 to about 25, from about 15 to about 24, from about 16 to about 23, from about 17 to about 22, from about 18 to about 21 and from about 19 to about 20 nucleotides in length. In representative embodiments C and V regions comprise about 20 nucleotides in length.

A coding template can comprise from about 1 to about 100 or more different V regions (hybridization sequences) including about 200, about 300, about 500, or more different V regions. In representative embodiments, a coding template comprises from about 1 to about 50 different V regions, including about 2 to about 48, about 3 to about 46, about 4 to about 44, about 5 to about 42, about 6 to about 40, about 7 to about 38, about 8 to about 36, about 9 to about 34, about 10 to about 32, about 11 to about 30, about 12 to about 29, about 13 to about 28, about 13 to about 28, about 14 to about 27, about 15 to about 26, about 16 to about 25, about 17 to about 24, about 18 to about 23, about 19 to about 22, about 20 to about 21 different V regions.

A coding template can comprise from about 1 to about 100 or more different C regions (constant sequences), including about 200, about 300, about 500, or more different C regions. In representative embodiments, coding templates comprises from about 1 to about 50 different C regions, including about 2 to about 48, about 3 to about 46, about 4 to about 44, about 5 to about 42, about 6 to about 40, about 7 to about 38, about 8 to about 36, about 9 to about 34, about 10 to about 32, about 11 to about 30, about 12 to about 29, about 13 to about 28, about 13 to about 28, about 14 to about 27, about 15 to about 26, about 16 to about 25, about 17 to about 24, about 18 to about 23, about 19 to about 22, about 20 to about 21 different C regions.

Coding templates are synthesized such that regions Z₁ through Z (e.g., n=9) are linked to each other beginning with Z₁ at the 3′ and continuing in order with the linking entity or functional group at the 5′ end following Zₙ. For example, beginning with the 3′ end of the nucleic acid tag, Z₁ is linked to Z₂, Z₂ is linked to Z₃, Z₃ is linked to Z₄, etc., and the linking entity or functional group is linked to Z at any site on the oligonucleotide portion of coding template, including the 3′ terminus, the 5′ terminus, or any other position of the oligonucleotide.

As noted above, the population of coding templates is degenerate, i.e., almost all of the oligonucleotide portions of the coding templates differ from one another in nucleotide sequence. The nucleotide differences between coding templates reside entirely in the hybridization sequences (V regions). For example, an initial population of coding templates can comprise of 400 first sub-populations of oligonucleotide portions of the coding templates based on the particular sequence of V₁ of each sub-population. As such, the V₁ region of each sub-population comprises of any one of 400 different 20 base-pair hybridization sequences. Separation of such a population of coding templates based on V₁ would result in 400 different sub-populations of coding templates. Likewise, the same initial population of coding templates can also comprise of 400 second subpopulations of coding templates based on the particular sequence of V₂ of each subpopulation, wherein the second sub-populations are different than the first subpopulations.

In the exemplary population of coding templates demonstrated in FIG. 1, the first few of the first hybridization sequences are denoted as a₁, b₁, c₁ . . . j₁, in the V₁ region of the different coding templates. Likewise, the first few of the second hybridization sequences are denoted as a₂, b₂, c₂ . . . j₂, in the V₂ region of the different coding templates. The first few of the third hybridization sequences are denoted as a₃, b₃, c₃ . . . j₃, in the V₃, etc.

In certain embodiments, the coding templates share the same twenty base-pair sequence for designated spacer regions while having a different twenty base-pair sequence between different spacer regions. For example, the coding templates comprise the same C₁ spacer region, the same C₂ spacer region, and the same C₃ spacer region, wherein C₁, C₂, and C₃ are different from one another.

Thus each 180 nucleotide coding templates consists of an ordered assembly of 9 different twenty base-pair regions comprising the 4 variable regions (a₁, b₁, c₁ . . . d₅, e₅, f₅, . . . h₁₀, i₁₀, j₁₀) and the 5 spacer regions (z₁ . . . z₁₁) in alternating order. The twenty base-pair regions have the following properties: (i) micromolar concentrations of all the region sequences hybridize to their complementary DNA sequences efficiently in solution at a specified temperature designated Tm, and (ii) the region sequences are orthogonal to each other with respect to hybridization, meaning that none of the region sequences cross-hybridizes efficiently with another of the region sequences, or with the complement to any of the other region sequences, at the temperature Tm.

The degenerate coding templates can be assembled from their constituent building blocks by the primerless PCR assembly method described by Stemmer et al., Gene (1995) 164(1) 49-53 or by ligation strategies.

In some embodiments, capture templates are greater than 65, 66 or 67 nucleotides in length. In other embodiments, the hybridization sequence of the capture template is greater than 7 nucleotides in length. In still other embodiments, the portion of the capture template that does not hybridize to the coding template is greater than 45 nucleotides in length.

As noted above the coding templates include a ligand, linking entity or functional group at the 3′ terminus, the 5′ terminus, or any other position on the coding template. In some embodiments, the ligand, linking entity or functional group can be added by modifying the 5′ alcohol of the 5′ base of the oligonucleotide portion of the coding template with a commercially available reagent which introduces a phosphate group tethered to a linear spacer, e.g., a 12-carbon chain terminated with a primary amine group (e.g., as available from Glen Research, or numerous other reagents which are available for introducing thiols or other chemical reaction sites into synthetic nucleic acids).

The functional group of the linking entity or functional group is the site at which a particular ligand is synthesized dictated by the order of V region sequences of the coding templates. An exemplary functional group is a primary amine. Many different types of functional groups in addition to primary amines can be introduced at any site, including the 3′ terminus, the 5′ terminus, or any other position on the coding template. Exemplary functional groups include, but are not limited to, chemical components capable of forming amide, ester, urea, urethane, carbon-carbonyl bonds, carbon-nitrogen bonds, carbon-carbon single bonds, olefin bonds, thioether bonds, and disulfide bonds. In the case of enzymatic synthesis, co-factors may be supplied as are required for effective catalysis. Such co-factors are known to those of skill in the art. An exemplary cofactor is the phosphopantetheinyl group useful for polyketide synthesis.

An entire combinatorial library is synthesized by carrying out alternate rounds of coding template splitting and chemical and/or biochemical coupling of chemical subunits to the linking entity or functional group of the coding template.

The plurality of chemical compounds produced are linked to nucleic acid sequence tags which facilitate identification of the chemical structure. Conventional DNA sequencing methods are readily available and useful for a determination of the sequence of the synthesis-directing nucleic acid tags. (See, e.g., Maniatis et al., eds., “Molecular Cloning: A Laboratory Manual”, Second Edition, Cold Spring Harbor, N.Y. (1989)). Especially useful is Next Gen DNA sequencing which is well known to those of skill in the art.

The compound library may be screened for a desired activity, for example, the ability to catalyze a particular reaction or to bind with high affinity to an immobilized receptor. In most cases, the subpopulation of molecules with the desired activity, as well as their nucleic acid tags, are physically partitioned away from siblings during the selection. Following selection, the nucleic acid tags attached to the selected molecules are synthesized by the polymerase chain reaction (“PCR”) (Saiki et al., Science (1988) 239(4839) 487-491). The 5′hydroxyl of the 5′-end primer used to synthesize the coding strand is modified with a phosphate group tethered to a fresh primary amine chemical reaction site. After synthesis, the coding strand is separated from the non-coding strand. Because the nucleic acid tags direct the library synthesis, rather than merely reporting on the synthetic history of individual compounds, the coding strands amplified from the first library can be used to direct the construction of a second generation compound library. Iteration of this procedure, by carrying out multiple rounds of selection, DNA tag amplification, and library resynthesis, allows individual desirable compounds to be amplified from extremely complex libraries.

An entire compound library or individual library members produced by the above may be evaluated for one or more desired activities in screening assays capable of distinguishing compounds which modulate an activity or possess a desired structural or functional property. Exemplary assays and functional analyses include, but are not limited to, enzymatic assays, non-enzymatic catalytic assays, protein-protein binding assays, receptor/ligand binding assays and cell-based assays. More specifically, exemplary cell-based methods are based on; (1) differential binding of library compounds to a cell surface (i.e., binding to cancer cell and not a non-cancer cell); (2) binding of library compounds to components of a cell extract (e.g., binding to a cell fraction produced by separating an entire cell extract on a sucrose gradient); (3) library compounds capable of endocytosis by a cell and (4) in vivo localization and binding properties of library compounds by injecting the library into an animal. (See, e.g., Arap et al., Science (1998) 279(5349) 377-80 which describes in vivo selection of phage display libraries to isolate peptides that home specifically to tumor blood vessels). As will be appreciated by those of skill in the art, such assays may be performed on entire libraries of compounds synthesized by the methods described herein or sub populations derived therefrom.

Desired ligands produced by the combinatorial library methods described herein include, but are not limited to, oligonucleotides, single stranded RNA, single stranded DNA, DNA binding proteins, RNA binding proteins, peptide nucleic acids, peptides, depsipeptides, polypeptides, antibodies, peptoids, polymers, polysiloxanes, inorganic compounds of molecular weight greater that 50 daltons, organic compounds of molecular weight between about 3000 daltons and about 50 daltons or combinations thereof.

In addition to allowing amplification of selected library members, the method permits evolution of the encoded compound libraries. More specifically, genetic recombination between the nucleic acid tags which encode selected subpopulations of compounds is carried out in vitro by mutagenesis or random fragmentation of the nucleic acid tag sequence, followed by the generation of related nucleic acid sequences (“gene shuffling”, Stemmer, Nature, (1994) 370 389-391; Stemmer et al., U.S. Pat. No. 5,811,238) and subsequent step-wise synthesis of additional compounds. Iteration of this procedure, by carrying out multiple rounds of selection, DNA tag amplification, genetic recombinations and library resynthesis, allows individual desirable compounds to evolve from extremely complex libraries.

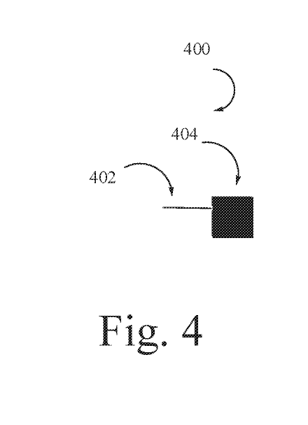

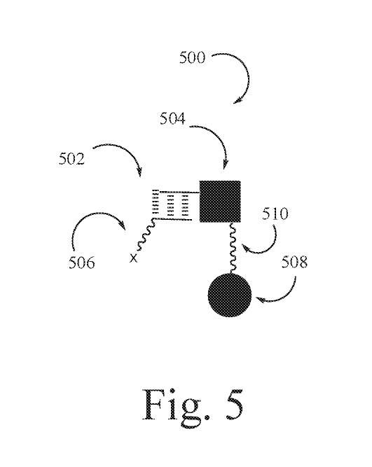

FIGS. 4-16 describe and illustrate assembly of architectures and compositions of capture templates and macro capture templates and novel combinations of solid supports and macro capture templates, which may be used to fractionate a mixture of coding templates in the various methods of routing described herein. Also illustrated in many of the figures, are novel compositions which include capture templates and macro capture templates, optionally attached to dendrimers, hybridized to coding templates and novel compositions including solid supports, optionally dendrimers and capture templates and/or macro capture templates hybridized to coding templates. In FIGS. 5, 6, 8, 9, 11, 12, 14, 15 and 16, X represents either a ligand, functional group or a linking entity. It should be understood, that the depictions below are illustrative rather than comprehensive and are not limiting to any extent.

FIG. 4 illustrates a capture template molecule 400 where capture template 402 may be optionally attached to linker, label or a secondary capture template 404.

FIG. 5 illustrates complex 500 where capture template 502 is hybridized to coding template 506 while linker 504 is attached to solid support 508 through another linker 510.

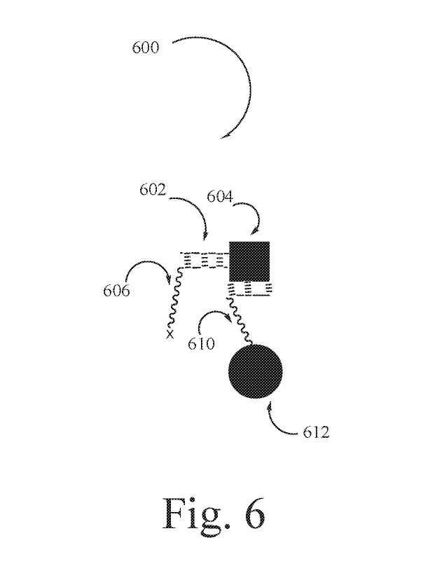

FIG. 6 illustrates complex 600 where capture template 602 is hybridized to coding template 606, while secondary capture template 604 is hybridized to complementary oligonucleotide 610 attached to solid support 612. Complementary oligonucleotide 610 can also be attached to solid support through a linker (not illustrated).

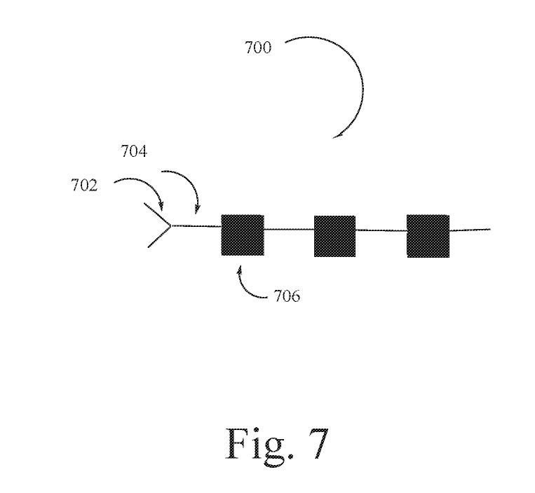

FIG. 7 illustrates macro capture template 700, which includes label 702, which in some embodiments is a biological label, attached to capture template 704. Macro capture template 700 optionally includes linker 706 which can render the capture templates 704 of macro capture template 700 non-contiguous.

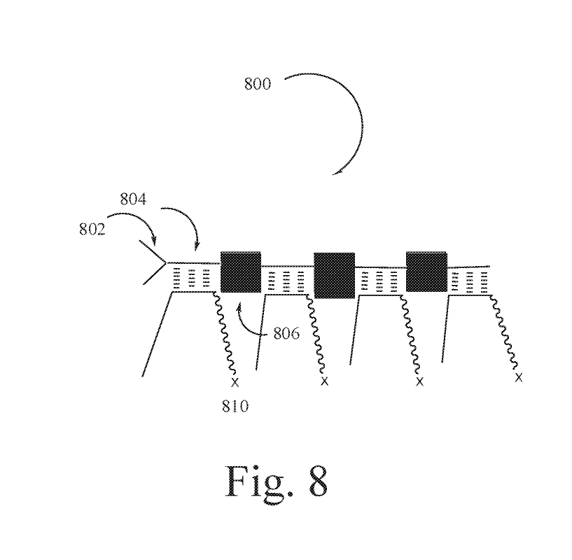

FIG. 8 illustrates a complex 800 which includes capture templates 804, that are hybridized to coding templates 810, optionally separated by linkers 806. As illustrated, label 802 is attached to a terminal capture template. In some embodiments, label 802 is attached to a linker.

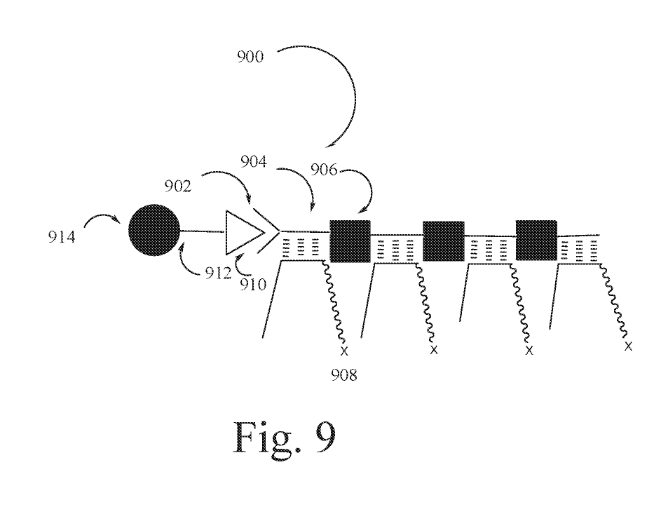

FIG. 9 illustrates a complex where label 902, which in some embodiments is a biological label, forms a complex with agent 910, which in some embodiments is a biological agent attached to solid support 914. Macro capture template 900 includes label 902 attached to capture template 904, which is hybridized to coding template 908. Macro capture template 900 optionally includes linker 906 which render capture templates 904 non-contiguous. Label 902 forms a complex with agent 910 which is attached to a solid support 914 by linker 912. In some embodiments, agent 910 may be directly attached to solid support 914.

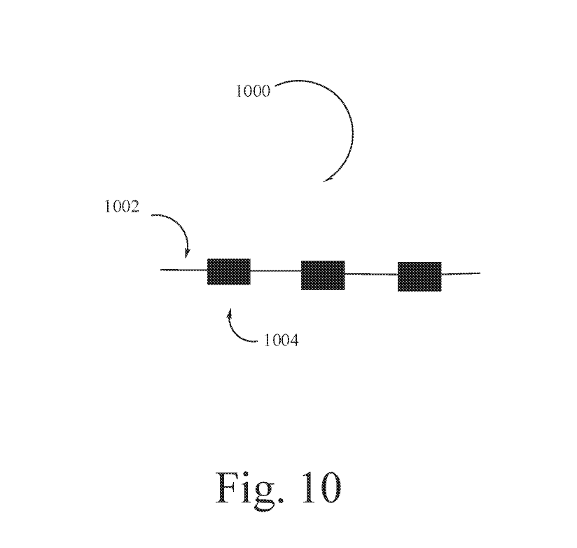

FIG. 10 illustrates macro capture template 1000 which includes multiple capture templates 1002 interspersed with secondary capture templates and/or linkers 1004. The arrangement of capture templates 1002 and secondary capture templates and/or linkers 1004 may be regular or random and that the ratio the above in macro capture template 1000 may vary widely.

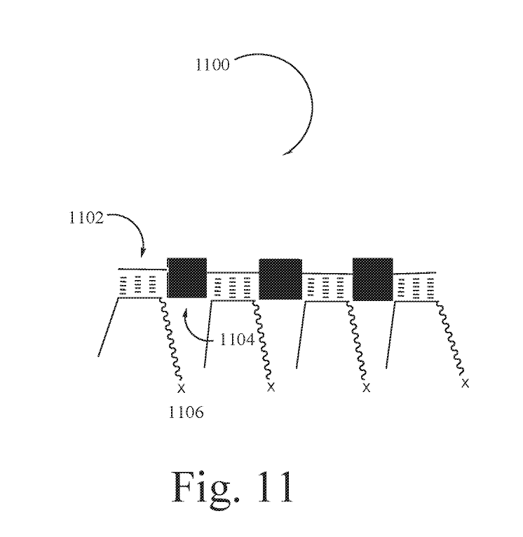

FIG. 11 illustrates complex 1100, which includes capture template 1102 interspersed with secondary capture templates and/or linkers 1104. Capture templates 1102 are hybridized to coding template 1106.

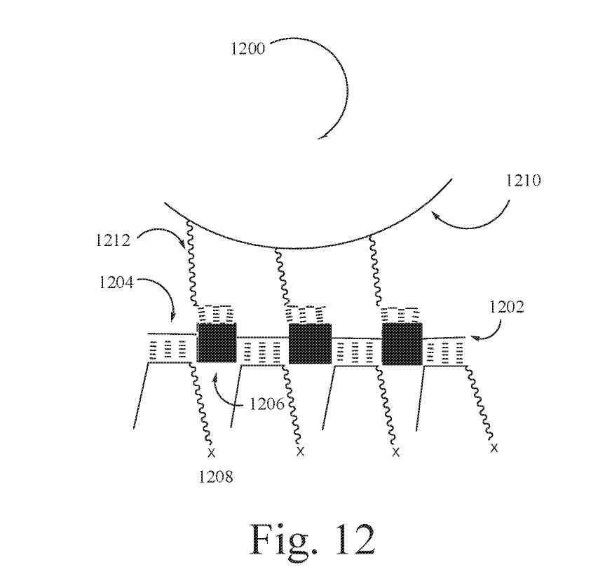

FIG. 12 illustrates a complex 1200, which includes, macro capture template 1202 comprised of capture template 1204 and secondary capture template 1206. Capture templates 1204 are hybridized to coding templates 1208. Secondary capture templates 1206 are hybridized to complementary oligonucleotides 1212 which is attached to solid support 1210 to form complex 1200.

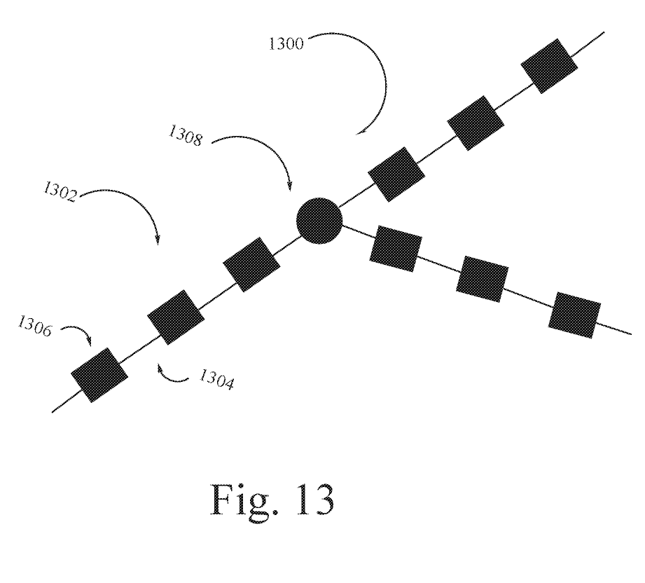

FIG. 13 illustrates a complex 1300 which includes multiple macro capture templates 1302 attached to dendrimer 1308. Macro capture template 1302 includes capture templates 1304 and secondary capture templates or linkers 1306. The number of macro capture templates attached to a dendrimer can vary and is limited primarily by dendrimer structure.

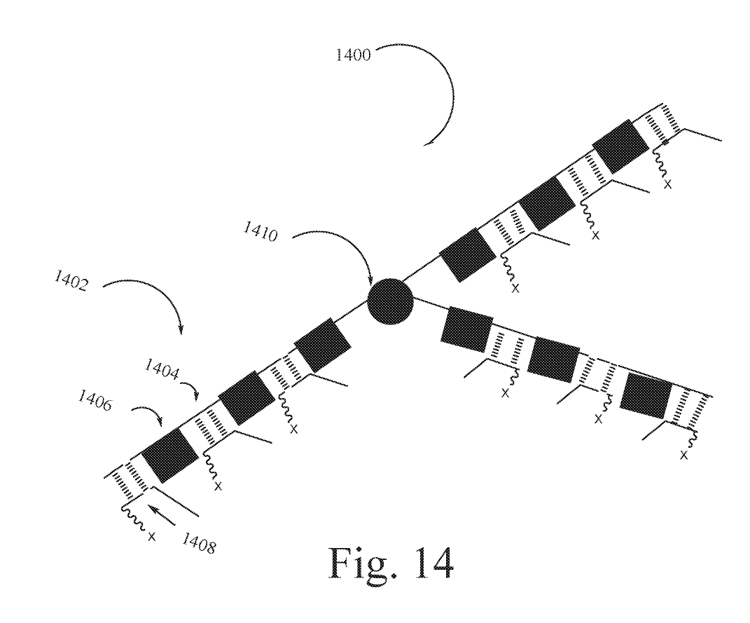

FIG. 14 illustrates a complex 1400 which includes multiple macro capture templates 1402 attached to dendrimer 1410. Macro capture template 1402 includes capture templates 1404 and secondary capture templates or linkers 1406 where capture templates 1404 are hybridized to coding template 1408.

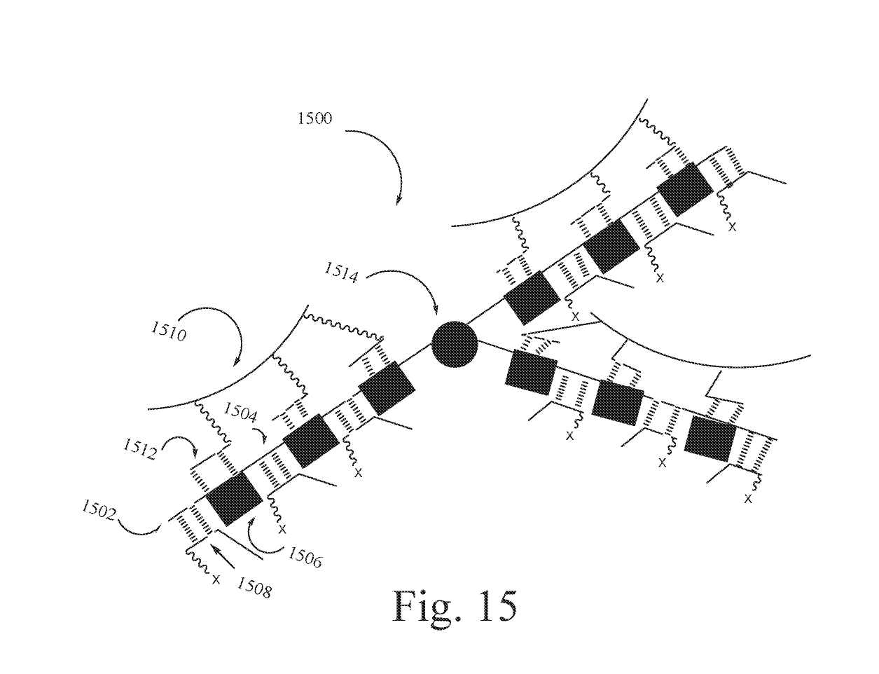

FIG. 15 illustrates complex 1500, where multiple macro capture templates 1502 are attached to dendrimer 1514, capture templates 1504 are hybridized to coding templates 1508, secondary capture templates 1506 are hybridized to complementary oligonucleotides 1512 attached to solid support 1510. The solid support can be, for example, a surface, one bead or multiple beads

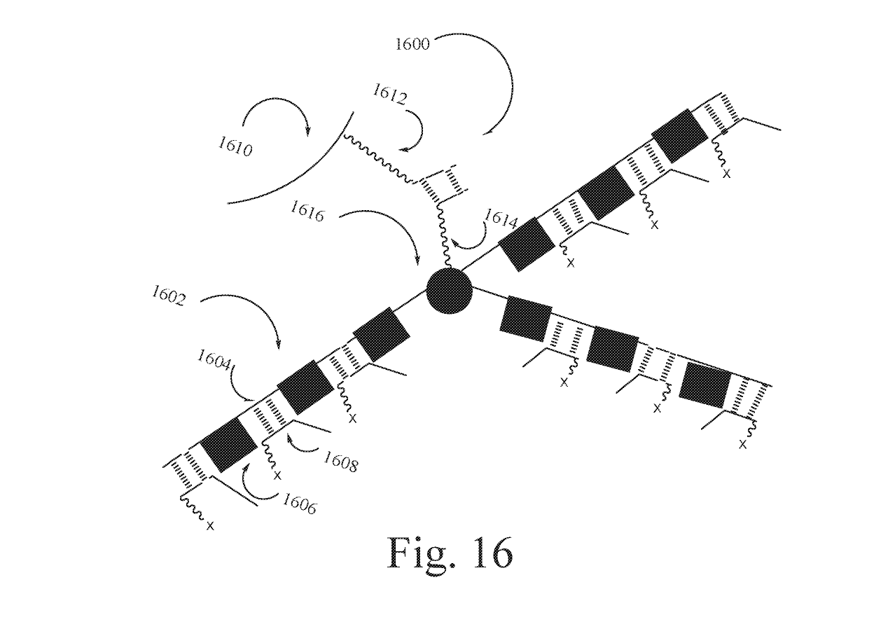

FIG. 16 illustrates complex 1600 where multiple macro capture templates 1602 are attached to dendrimer 1616, capture templates 1604 are hybridized to coding templates 1608 and oligonucleotide 1614 attached to dendrimer is hybridized to complementary oligonucleotide 1612 attached to solid support 1610 is. Macro capture templates 1602 includes capture templates 1604 and secondary capture templates or linkers 1606 and is attached to dendrimer 1616.

The architectures and compositions of capture templates and macro capture templates and novel combinations of solid supports and macro capture templates and novel complexes disclosed in the Figs. may be used to fractionate mixtures of coding templates in the various methods below.

In some embodiments, a method of routing mixtures of n coding templates to more than one spatial location is provided where n is an integer greater than 1. The method includes the steps of adding the mixture of coding templates to spatially localized capture templates, forming base specific duplexes between coding templates complementary to the spatially localized capture templates, transferring the unhybridized coding templates to other spatially localized capture templates, forming base specific duplexes between the coding templates complementary to the spatially localized capture templates and either transferring the unhybridized coding templates to another spatial location or repeating the third and fourth steps n−1 times.

In other embodiments, a method of routing mixtures of n coding templates into more than one spatial location is provided where n is an integer greater than 1. The method includes the steps of adding the mixture of coding templates to spatially localized macro capture templates, forming base specific duplexes between coding templates complementary to the spatially localized macro capture templates, transferring the unhybridized coding templates to other spatially localized macro capture templates, forming base specific duplexes between the coding templates complementary to the spatially localized macro capture templates and either transferring the unhybridized coding templates to another spatial location or repeating the third and fourth steps n−1 times.

In some embodiments, capture templates or macro capture templates are attached to magnetic beads which are spatially localized. In these embodiments, a magnetic field may be used to spatially localize magnetic beads. In still other embodiments, capture templates or macro capture templates are attached to beads which differ in color and may be sorted, for example, by FACS and then spatially localized. In still other embodiments, n templates or macro capture templates are attached to n spatially localized macroscopic beads.

In other embodiments, capture templates or macro capture templates are attached to beads which are spatially localized by irreversible complex formation. For example, biotinylated beads with attached capture templates can be immobilized in discrete spatial locations by reaction with streptavidin or avidin attached to discrete spatial location (e.g., wells, surfaces, etc.). Other examples of formation of irreversible complex formation between biological molecules are within the ambit of the skilled artisan.

In some embodiments, a method of routing mixtures of coding templates to more than one spatial location is provided. The method includes the steps of adding more than one capture template spatially localized with a multivalent device to a mixture of coding templates and forming base specific duplexes between the coding templates and the spatially localized capture templates.

In other embodiments, a method of routing mixtures of coding templates to more than one spatial location is provided. The method includes the steps of adding more than one macro capture templates spatially localized with a multivalent device to a mixture of coding templates and forming base specific duplexes between the coding templates and the spatially localized macro capture templates.

The multivalent device may be, for example, a magnetic device with multiple prongs. Magnetic beads with known capture templates and/or macro capture templates can be attached to specific prongs of the multivalent device by a magnetic field, when the prongs are arrayed over the specific discrete spatial locations where the beads are isolated. The beads attached to the multivalent device are then contacted with a pool of coding templates. After hybridization with coding templates the beads are delivered to unique spatial locations by arraying the arms over discrete containers (e.g., distinct wells in a well plate) and demagnetizing the device.

Multivalent devices, such as the KingFisher™ system, are available from commercial suppliers (e.g., Thermo Fisher Scientific) and are designed to be used with magnetic beads. The KingFisher™ system has well heads, which are spatially distinct, that bind magnetic beads when electromagnetically activated. Magnetic beads are available from commercial suppliers (e.g., Perkin Elmer, Waltham, Mass.; Bioclone, Inc., San Diego, Calif. etc.) in various functional forms (i.e., beads functionalized, for example, with azide, epoxy, carboxy, amino groups or streptavidin, etc.). Accordingly, attachment of capture templates to magnetic beads is well with the ambit of the skilled artisan. See also, Dressman et al., Proc. Natl. Acad. Sci., 2003, 100, 15, 8817,

In some of the above embodiments, capture templates are attached to supports which are encompassed by a container permeable to nucleic acids and solvents. The container may be, for example, a membrane or mesh whose pore sizes are small enough to retain capture templates attached to supports but large enough to be permeable to nucleic acids. Then attachment of the container, which includes capture templates attached to supports, to a device with multiple well heads is followed by immersion of the well heads in a coding template reservoir until hybridization is complete. In some embodiments, the container is attached to the device by adhesive or mechanical means. The capture templates encompassed container which are now hybridized to coding templates are then dispersed to spatially distinct locations by disruption of the adhesive or mechanical means of attachment in a defined fashion.

In some embodiments, a method of routing mixtures of coding templates to more than one spatial location is provided. The method includes the steps of adding the mixture of coding templates to more than one capture template, where each capture template includes at least one secondary capture template, forming base specific duplexes between coding templates and complementary capture templates, forming base specific duplexes between the secondary capture templates and complementary oligonucleotides attached to spatially localized beads, sortable beads, solid supports in spatially localized containers or in sortable containers.

In other embodiments, a method of routing mixtures of coding templates to more than one spatial location is provided. The method includes the steps of adding the mixture of coding templates to more than one macro capture template, base specific duplexes between coding templates and complementary capture templates, forming base specific duplexes between the secondary capture templates and complementary oligonucleotides attached to spatially localized beads, sortable beads, solid supports in spatially localized containers or in sortable containers.

In the above embodiments, the secondary capture template serves as a barcode which allows for routing of the coding template through selective hybridization. Other barcodes could include, for example, oligonucleotides of variable length, which could allow for resolution of complexes of coding templates and capture templates and/or macro capture templates on the basis of size or ligands which differentiate the complexes on the basis of polarity, charge, etc. Such complexes could be resolved by chromatography or gel electrophoresis to provide spatially localized coding templates after disruption of hybridization.

In still other embodiments, a method of routing mixtures of coding templates to more than one spatial location is provided. The method includes the steps of adding the mixture of coding templates to more than one capture template, wherein each capture template is attached to a dendrimer and which includes at least one secondary capture template, forming base specific duplexes between the coding templates and complementary capture templates attached to the dendrimers and forming base specific duplexes between the secondary capture templates and complementary oligonucleotides attached to spatially localized beads, sortable beads, solid supports in spatially localized containers or in sortable containers.

In still other embodiments, a method of routing mixtures of coding templates to more than one spatial location is provided. The method includes the steps of adding the mixture of coding templates to more than one macro capture template, where each macro capture template is attached to a dendrimer, forming base specific duplexes between the coding templates and complementary macro capture templates attached to the dendrimers and forming base specific duplexes between secondary capture templates and complementary oligonucleotides attached to spatially localized beads, sortable beads, solid supports in spatially localized containers or in sortable containers.

In still other embodiments, a method of routing mixtures of coding templates to more than one spatial locations is provided. The method includes the steps of adding the mixture of coding templates to more than one capture template, wherein each capture template includes a label and is attached to a dendrimer, forming base specific duplexes between the coding templates and complementary capture templates attached to the dendrimers and using the label to attach the dendrimers to spatially localized beads, sortable beads, solid supports in spatially localized containers or in sortable containers.

In still other embodiments, a method of routing mixtures of coding templates to more than one spatial location is provided. The method includes the steps of adding the mixture of coding templates to more than one macro capture template, where each macro capture template is attached to a dendrimer which includes a unique label, forming base specific duplexes between the coding templates and complementary capture templates attached to the dendrimers and using the label to attach the dendrimers to spatially localized beads, sortable beads, solid supports in spatially localized containers or in sortable containers.

In still other embodiments, a method of routing mixtures of coding templates to more than one spatial location is provided. The method includes the steps of adding the mixture of coding templates to more than one capture template, where each capture template is attached to a dendrimer which includes a unique label, forming base specific duplexes between the coding templates and complementary capture templates of the capture templates attached to the dendrimers and using the label to attach the dendrimers to spatially localized beads, sortable beads, solid supports in spatially localized containers or in sortable containers.

In still other embodiments, a method of routing mixtures of coding templates to more than one spatial locations is provided. The method includes the steps of adding the mixture of coding templates to more than one macro capture template, wherein each macro capture template includes a label and is attached to a dendrimer, forming base specific duplexes between the coding templates and complementary capture templates attached to the dendrimers; using the label to attach the dendrimers to spatially localized beads, sortable beads, solid supports in spatially localized containers or in sortable containers.

In some embodiments, the label is a secondary capture template. In other embodiments, the secondary capture template forms base specific duplexes with oligonucleotides attached to spatially localized beads, sortable beads or within sortable containers or a container including resins, beads or combinations thereof.

In other embodiments, the label is a biological label. The label can be, for example, an antibody substrate, an irreversible receptor binder, an irreversible enzyme inhibitor or combinations thereof. The label may form an irreversible complex with unique biological agents attached to spatially localized beads, within sortable beads or spatially localized resins or beads encompassed by a container permeable to the duplexes. The label may be an electromagnetic device, a mass spectroscopy tag, a semiconductor chip, an RF transmitter, optical storage device, etc. (Nova et al., U.S. Pat. No. 5,741,462).

In some embodiments, the spatially localized beads are magnetic beads. In other embodiments, beads are sortable by color, size, shape, density or combinations thereof. Numerous functionalized colored beads are available from commercial sources such as Thermo Fisher Scientific (San Jose, Calif.), Sigma Aldrich (St Louis Mo.) and Sperotech, Inc. (Lake Forest, Ill.). Attachment of capture templates to these particles is with the ambit of the skilled artisan.

The beads may be beads sortable by FACS to a unique spatial location. Many dyes and combinations of dyes including lanthanide and organic dyes may be used to form colored beads with different fluorescence profiles that can effectively be sorted by FACS. (Maecker et al., Nature Methods, an6, 2008; Perfetto et al., Nature Reviews 648, 2004; Autisser et al., Cytometry, 410, 2010).

Sortable containers may include capture templates attached to supports and an attached label. The container may be, for example, a membrane or mesh whose pore sizes are small enough to retain capture templates attached to supports but large enough to be permeable to nucleic acids. The sortable containers have an additional label which may be any of the labels described above. The label identifies the container and allows for delivery of a particular container to a unique spatially localized location.

In some embodiments, capture templates are included in a macro capture template. In other embodiments, more than one label is included in the macro capture template. In still other embodiments, the ratio of label and capture template is between about 10:1 and 1:10. In still other embodiments, the ratio of label and capture template is between about 5:1 and 1:5. In still other embodiments, the ratio of label and capture template is between about 2:1 and 1:2. In still other embodiments, the macro capture template comprises between about 1 and about 100 capture templates. In still other embodiments, the macro capture template includes between about 1 and about 50 capture templates. In still other embodiments, the macro capture template includes between about 1 and about 25 capture templates. In still other embodiments, the macro capture template includes between about 1 and about 15 capture templates. In still other embodiments, the macro capture template includes between about 1 and about 5 capture templates. In still other embodiments, the capture templates are separated by one of more labels, linkers or combinations thereof. In still other embodiments, the label is at either the 3′ or 5′ end of the capture template or at both ends.

In still other embodiments, a method of routing mixtures of coding templates to more than one spatial location is provided. The method includes the steps of adding the mixture of coding templates to n macroscopic beads wherein each macroscopic bead includes attached capture templates and unique attached labels, forming base specific duplexes between the coding templates and the complementary capture templates of the macroscopic beads, sorting the n macroscopic beads to n spatial locations, using the label to identify the bead, eluting the coding templates from the bead and arraying the coding templates to n spatial locations.

In still other embodiments, a method of routing mixtures of coding templates to more than one spatial location is provided. The method includes the steps of adding the mixture of coding templates to n macroscopic beads where each macroscopic bead includes attached macro capture templates which include unique labels, forming base specific duplexes between the coding templates and the complementary capture templates of the macroscopic beads, sorting the n macroscopic beads to n spatial locations, using the label to identify the bead; eluting the coding templates from the bead; and arraying the coding templates to n spatial locations.

In some of the above embodiments, macroscopic beads may be manually dispersed into discrete spatial locations and the coding template eluted from the bead by disruption of hybridization. After separation from the bead and deposition into a discrete location the identity of each coding template may be determined, for example, by Next Gen sequencing.

In some embodiments, each macroscopic bead includes more than about 100 picomoles of capture template. In other embodiments, each macroscopic bead includes at least about 100 picomoles of capture template. In still other embodiments, the beads are sorted by large particle sorter. The label may be a mass spectroscopy label, FACS label, radiofrequency label, a DNA sequence or a biological label. In still other embodiments, the bead is identified by mass spectroscopy, FACS, DNA sequencing or a biological agent.

In many of the above embodiments, the solid support may be resins (Sepharose, agarose, DEAE, polystyrene, etc.), beads (e.g., magnetic, colored, macroscopic, porous, nonporous, etc.) or monoliths. In general, the capture or macro capture template will be attached to a solid support by either directly through covalent bond formation or indirectly through base specific duplex formation with an oligonucleotide attached to the solid support. In many of the above embodiments the coding templates are agitated at a temperature of about 10° below the Tₘ of base specific duplex formation between the coding templates and capture templates with the coding templates. In other of the above embodiments, the capture templates are attached to the beads or resin by a covalent bond, through base specific duplex formation or biological binding event.

In some embodiments, macro capture templates may be attached to monoliths and used to fractionate mixtures of coding templates as described in Harbury et al., U.S. Patent Application No. 2015/0209753.

In some embodiments, the linear density of the capture template or macro capture template on a solid support is between 100 μM/m and about 0.05 μM/m. In other embodiments, the linear density of the capture template or macro capture template on a solid support is between 10 μM/m and about 0.5 μM/m. In still other embodiments, the linear density of the capture template or macro capture template on a solid support is between 5 μM/m and about 1.5 μM/m. In still other embodiments, the linear density of the capture template or macro capture template on a solid support is about 3.3 μM/m. In still other embodiments, the density of the capture template or macro capture template on a solid support is between about 1 pm/10 μl and about 1 μmol/10 μl. In still other embodiments, the density of the capture template or macro capture template on a solid support is about 1 nm/10 μl.

In some embodiments, the rate constant of binding to complementary nucleic acid sequences of the capture templates is between about 1×10² M⁻¹s⁻¹ and about 1×10⁶ M⁻¹s⁻¹. In other embodiments, the rate constant of binding to complementary nucleic acid sequences of the capture templates is between about 1×10³ M⁻¹s⁻¹ and about 1×10⁶ M⁻¹s⁻¹. In other embodiments, the rate constant of binding to complementary nucleic acid sequences of the capture templates is between about 1×10² M⁻¹s⁻¹ and about 1×10⁵ M⁻¹s⁻¹.

Functional groups on the solid supports may be directly functionalized with capture templates or macro capture templates, example, by ether, ester or amide bond formation, if the capture templates or macro capture templates, contains complementary functionality. In some embodiments, cycloaddition of complementary functional groups (e.g., azide and acetylene; diene and electron deficient olefin) or click chemistry (Evans, Australian J. of Chemistry, 60 (6): 384-395 (2007) may be used to attach the capture templates or macro capture templates to the solid support.

Alternatively, a bifunctional linker may be attached to the functional groups of the solid support and the capture templates or macro capture templates covalently bonded to the solid support through formation of amide, carbamate, ester, urea, urethane, carbon-nitrogen, carbon-carbon, ether, thioether or disulfide bond with a complementary functional group on the bifunctional linker. In some embodiments, cycloaddition of complementary functional groups (e.g., azide and acetylene; diene and electron deficient olefin) or click chemistry may be used to attach the linker covalently bonded to the solid support to the capture templates or macro capture templates.

In addition, the capture templates or macro capture templates may be functionalized with a linker, which contains functional groups capable of reacting with the functional groups on the solid supports. As before, capture templates or macro capture templates attached to a linker may be covalently bonded to a solid support through formation of an amide, carbamate, ester, urea, urethane, carbon-nitrogen, carbon-carbon, ether, thioether or disulfide bond with a complementary functional group on the linker. In some embodiments, cycloaddition of complementary functional groups (e.g., azide and acetylene; diene and electron deficient olefin) or click chemistry may be used to attach the solid support to the linker covalently bonded to the capture templates or macro capture templates.

All publications and patents cited herein are incorporated by reference in their entirety to disclose and describe the methods and/or materials in connection with which the publications are cited. It is understood that the present disclosure supersedes any disclosure of an incorporated publication to the extent there is a contradiction. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The following examples are provided for illustrative purposes only and are not intended to limit the scope of the invention.

### EXAMPLES

### Example 1: Preparation of Magnetic Beads with Attached Capture Templates

The coupling buffer (1200 μL 5M NaCl, 1200 μL IM NaPO₄ (pH 7), 150 μL 100 mM aminoguanidine, 6 mL water, 120 μL 0.5% Triton-X-100) was sparged with N₂ for 5 minutes. 100 mM ascorbate was sparged and sonicated. Azide magnetic beads (Jena Bioscience, Gena, Germany) were then washed with 500 μL water (3×), 500 μL of ES2 buffer (20 mM NaOH, 15 mM Na Cl, 0.02% SDS, 0.005% Triton-X-100) for 5 minutes, excess liquid removed, 500 μL water, excess liquid removed, 500 μL coupling buffer (2×), suspended in 150 μL coupling buffer to equilibrate (at least 10 minutes) and excess liquid removed. Then 90 μL coupling buffer, 2.5 μL of 100 MM ascorbate and 2.5 μL of 1 of unique mM hexynyl-oligonucleotide designed to be complementary to one coding template of the DNA library was added independently to 3 different tubes (each tube contains a unique capture template and the number of tubes is an experimental variable), with continuous sparging. 3 μL Cu/THPTA mixture (12.5 μL, 50 mM CuSO₄ was mixed with 6.5 μL 500 mM THPTA) was added with sparging. The tubes were incubated for 30 minutes at 37° C., with shaking at 1400 rpm and 5 μL ascorbate was added and shaking incubation continued for 30 more minutes. The beads were then washed with TE buffer (10 mM Tris, pH 8.0, 1 mM EDTA) (3×) and stored in 100 μL of TE buffer.

### Example 2: Routine of DNA Library with Capture Templates Attached to Magnetic Beads

About 30 μL of a 540 μL DNA library (Weisenger et al., PLOS One, e28056) is set aside for qPCR assay. To the remaining library is added 10 μL of 0.5 mg/mL tRNA, 5 μL 2% SDS and 5 μL of 0.5% Triton X-100 to provide a total library volume of 530 μL. The magnetic beads prepared in Example 1, dispersed into 3 separate tubes, are washed with 150 mL ES2 (3×), 500 μL HBE2tRNA (150 mM NaCl, 15 mM sodium citrate, 0.02% SDS, 0.005% Triton-X-100, 0.2 ethanolamine, 10 μg tRNA, 50 mM Tris-HCl, pH 7.5) (3×) and excess liquid is removed. The beads in the tubes are sequentially interrogated with the DNA library. Each tube with beads is incubated with the DNA library at 40° C. with shaking at 1400 rpm for 1 hour followed by transferring the supernatant to the next tube. The incubation is repeated until every tube is incubated with the DNA library. The beads remaining in the tubes are washed with 500 μL of HBE2tRNA (6×) and excess liquid is removed. The fractionated DNA library present in each tube is then eluted with 30 μL of ES2 buffer and is neutralized with 3 μL of 1 M Tris-HCl, pH 7.5. The beads are then washed 100 μL of TE buffer and stored in TE buffer at 4° C. The eluted, fractionated DNA library from each tube is analyzed by qPCR and NextGen sequencing to confirm identity.

1. A method of routing mixtures of coding templates to more than one spatial location comprising:
adding more than one capture template spatially localized with a multivalent device to the mixture of coding templates; and
forming base specific duplexes between the coding templates and the spatially localized capture templates.

2. The method of claim 1, wherein the multivalent device is a multivalent magnetic device.

3. A method of routing mixtures of coding templates to more than one spatial location comprising:
adding the mixture of coding templates to more than one capture template, where each capture template includes at least one secondary capture template;
forming base specific duplexes between coding templates and complementary capture templates; and
forming base specific duplexes between the secondary capture templates and complementary oligonucleotides attached to spatially localized beads, sortable beads or solid supports in spatially localized containers or in sortable containers.

4. A method of routing mixtures of coding templates to more than one spatial location comprising:
adding the mixture of coding templates to more than one capture template, wherein each capture template includes at least one unique label;
forming base specific duplexes between the coding templates and complementary capture templates; and
using the label to attach duplexes to spatially localized beads, sortable beads or solid supports in spatially localized containers or in sortable containers.
